(19) United States
(12) Patent Application Publication
(10) Pub. No.: US 2015/0139015 A1
(43) Pub. Date: May 21, 2015

(54) LTE Band Avoidance for RF Coexistence Interference

(71) Applicant: QUALCOMM Incorporated, San Diego, CA (US)

(72) Inventors: Tamer Adel KADOUS, San Diego, CA (US); Pranav Dayal, San Diego, CA (US); Ashok Mantravadi, San Diego, CA (US); Peter Gaal, San Diego, CA (US); Jibing Wang, San Diego, CA (US); Cheol Hee Park, San Diego, CA (US); Reza Shahidi, San Diego, CA (US); Alexei Yurievitch Gorokhov, San Diego, CA (US); Levent Aydin, San Diego, CA (US)

(21) Appl. No.: 14/599,788

(22) Filed: Jan. 19, 2015

Related U.S. Application Data
(63) Continuation-in-part of application No. 13/229,819, filed on Sep. 12, 2011.
(60) Provisional application No. 61/385,371, filed on Sep. 22, 2010.
(60) Provisional application No. 62/092,314, filed on Dec. 16, 2014.

(51) Int. Cl. H04W 24/08; H04L 5/00; H04W 36/00; H04W 72/08

(52) U.S. Cl. CPC H04W 24/08; H04W 72/082; H04L 5/0062; H04W 36/0088; H04L 5/0073
USPC 370/252

(57) ABSTRACT

Various embodiments enable a multi-active mobile communication device to mitigate (manage) interference by a frequency band used by a first subscription with the frequency band used by a second subscription. The device processor may generate modified power measurements for one or more frequency bands of a first subscription and use the modified power measurement(s) to cause the first subscription to switch from the frequency band that interferes with the frequency band of the second subscription. The modified power measurement may be a decreased power measurement of the first frequency band and/or an increased power measurement of a second frequency band that does not interfere with the frequency band of the second subscription. As a result, various embodiments may mitigate or otherwise manage the impact of coexistence interference between the first and second subscriptions of a multi-active mobile communication device without limiting capabilities of the device or changes to the network.

### CROSS REFERENCE TO RELATED APPLICATION

This application is a continuation-in-part of U.S. patent application Ser. No. 13/229,819 entitled “MULTI-RADIO COEXISTENCE” filed Sep. 12, 2011, which claims the benefit of U.S. Provisional Patent Application No. 61/385,371 entitled “METHOD AND APPARATUS TO FACILITATE SUPPORT FOR MULTI-RADIO COEXISTENCE,” filed Sep. 22, 2010. This application also claims the benefit of priority to U.S. Provisional Application No. 62/092,314 entitled “LTE Band Avoidance for RF Coexistence Interference” filed Dec. 16, 2014. The entire contents of all of these applications are hereby incorporated by reference.

### TECHNICAL FIELD

The present description is related, generally, to multi-radio techniques and, more specifically, to coexistence techniques for multi-radio devices.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out, or a multiple-in-multiple out (MIMO) system.

Some conventional advanced devices include multiple radios for transmitting/receiving using different Radio Access Technologies (RATs). Examples of RATs include, e.g., Universal Mobile Telecommunications System (UMTS), Global System for Mobile Communications (GSM), cdma2000, WiMAX, WLAN (e.g., WiFi), Bluetooth, LTE, and the like. An example mobile device includes an LTE User Equipment (UE), such as a fourth generation (4G) mobile phone. Such 4G phone may include various radios to provide a variety of functions for the user. For purposes of this example, the 4G phone includes an LTE radio for voice and data, an IEEE 802.11 (Wi-Fi) radio, a Global Positioning System (GPS) radio, and a Bluetooth radio, where two of the above or all four may operate simultaneously.

### SUMMARY

The various embodiments include methods and multi-subscription communication devices implementing the methods for managing coexistence interference between a first subscription and a second subscription by modifying signal power measurements for one or both of an interfering frequency band and a non-interfering frequency band of the first subscription so that the non-interfering frequency band is selected, thereby eliminating or reducing the coexistence interference with the second subscription. The various embodiments may be implemented on a variety of multi-active communication devices that include two or more radios configured to support two or more subscriptions simultaneously, including single subscriber identity module (SIM) dual-active communication devices and multi-SIM, multi-active communication devices. The method includes altering a channel measurement report of a first radio access technology based on interference from a radio of a second radio access technology. The method also includes reporting the altered channel measurement report to a serving cell.

In some embodiments, a method implemented on a mobile communication device for avoiding a coexistence interference between a first subscription and a second subscription in response to determining that a first frequency band used by the first subscription will interfere with a frequency band used by the second subscription may include generating a modified power measurement for one or both of the first frequency band and a second frequency band available to support the first subscription such that the modified power measurement reduces the likelihood that the first frequency band will not be used to support the first subscription and/or increases the likelihood that the second frequency band will be used to support the first subscription. In some embodiments, generating a modified power measurement for the first frequency band that reduces the likelihood that the first frequency band will be used to support the first subscription may include decreasing a power measurement for the first frequency band. In some embodiments, generating a modified power measurement of the second frequency band available to support the first subscription that increases the likelihood that the second frequency band will be used to support the first subscription may include increasing a power measurement for the second frequency band. Some embodiments may further include selecting as the second frequency band a frequency band that will not interfere with the frequency band used by the second subscription. Some embodiments may further include selecting as the second frequency band a frequency band that will cause less interference with the frequency band used by the second subscription than the first frequency band of the first subscription.

In some embodiments, the modified power measurement for the first and/or second frequency bands may be in the form of a modified Reference Signal Received Power (RSRP) measurement and/or a modified Reference Signal Received Quality (RSRQ) measurement.

In some embodiments reducing the power measurement for the first frequency band may include taking a power measurement of the first interfering frequency band of the first subscription, calculating a negative bias for the first interfering frequency band, and generating a modified power measurement for the first interfering frequency band by applying the negative bias to the power measurement of the first interfering frequency band.

In some embodiments increasing the power measurement for the second frequency band available to support the first subscription may include taking a power measurement of the second frequency band, calculating a positive bias for the second frequency band, and generating a modified power measurement for the second non-interfering frequency band by applying the positive bias to the power measurement of the second non-interfering frequency band.

Some embodiments may further include determining whether an operating state or frequency band of the second subscription has changed so that the first frequency band of the first subscription will no longer interfere with a frequency band of the second subscription, and using an actual power measurement for the first frequency band of the first subscription in response to determining that an operating state or frequency band of the second subscription has changed so that the first frequency band of the first subscription will no longer interfere with a frequency band of the second subscription.

Some embodiments may further include determining whether an operating state or frequency band of the second subscription has changed so that the first frequency band of the first subscription will no longer interfere with a frequency band of the second subscription, and continuing to use the modified power measurement for the first frequency band of the first subscription to avoid the coexistence interference in response to determining that an operating state or frequency band of the second subscription has not changed so that the first frequency band of the first subscription will interfere with a frequency band of the second subscription.

Some embodiments may further include identifying frequency bands available to support the first subscription that will interfere with the frequency band of the second subscription (“interfering frequency bands”) and frequency bands available to support the first subscription that will not interfere with the frequency band of the second subscription (“non-interfering frequency bands”), generating modified power measurement for each of the interfering frequency bands that reduces the likelihood that an interfering frequency band will be used to support the first subscription, and generating modified power measurement for each of the non-interfering frequency bands that increases the likelihood that a non-interfering frequency band will be used to support the first subscription.

Some embodiments may further include sending the modified power measurements to a network of the first subscription when the mobile communication device is operating in a connected mode, receiving, from the network, handover instructions for moving the first subscription to the second frequency band, wherein the handover instructions are based on the modified power measurement, and responding to the received handover instructions by configuring the first subscription to initiate a handover operation to the second frequency band.

Some embodiments may further include providing the modified power measurements to a component on the mobile communication device configured to support cell selection and cell reselection operations for the first subscription when the mobile communication device is operating in an idle mode, selecting, with the component, the second frequency band of the first subscription based on the modified power measurement, and configuring the first subscription to initiate one of cell selection and cell reselection to receive service via the second frequency band. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 illustrates a multiple-access wireless communication system according to various embodiments.

FIG. 2 is a block diagram of a communication system according to various embodiments.

FIG. 3 illustrates an exemplary frame structure in downlink LTE communications.

FIG. 4 is a block diagram conceptually illustrating a frame structure in uplink LTE communications according to various embodiments.

FIG. 5 illustrates an example wireless communication environment according to various embodiments.

FIG. 6 is a block diagram of an example design for a multi-radio wireless device according to various embodiments.

FIG. 7 is graph showing respective potential collisions between seven example radios in a given decision period according to various embodiments.

FIG. 8 is a diagram showing operation of an example Coexistence Manager (CxM) over time according to various embodiments.

FIG. 9 is a block diagram illustrating adjacent frequency bands.

FIG. 10 is a block diagram of a system for providing support within a wireless communication environment for multi-radio coexistence management according to various embodiments.

FIG. 11 is a process flow diagram illustrating a method for reporting adjusted channel measurement according to various embodiments.

FIG. 12 is a process flow diagram illustrating a method for reporting adjusted channel measurement according to various embodiments.

FIG. 13 is a block diagram illustrating components for adjusted channel measurement reporting according to various embodiments.

FIG. 14 is a block diagram illustrating components for adjusted channel measurement reporting according to various embodiments.

FIG. 15 is a component block diagram of a multi-SIM-multi-active communication device according to various embodiments.

FIG. 16A is a communication system block diagram illustrating an example of coexistence interference between a frequency band of an aggressor subscription and a frequency band of a victim subscription according to various embodiments.

FIG. 16B is a graph illustrating differences between actual signal power measurements and modified signal power measurements for an interfering frequency band and a non-interfering frequency band of a first subscription according to various embodiments.

FIGS. 17A-17B are example data tables including information regarding available and interfering frequency bands for a plurality of subscriptions operating on a multi-subscription-multi-active communication device according to various embodiments.

FIG. 18 is a process flow diagram illustrating a method for utilizing artificially adjusted power measurements of frequency bands of a first subscription to avoid coexistence interference with a second subscription according to various embodiments.

FIG. 19 is a process flow diagram illustrating a method for applying modifies to power measurements of frequency bands of a first subscription to generate modified power measurements according to various embodiments.

FIG. 20A is a signaling and call flow diagram illustrating communications exchanged between components on a mobile communication device and a network of a first subscription for generating modified power measurements for frequency bands of a first subscription while the first subscription is operating in a connected mode, according to various embodiments.

FIG. 20B is a signaling and call flow diagram illustrating communications exchanged between components on a mobile communication device for generating modified power measurements for frequency bands of a first subscription while the first subscription is operating in an idle mode, according to various embodiments.

FIG. 21 is a process flow diagram illustrating a method for utilizing modified power measurements to avoid coexistence interference while a first subscription is operating in one of a connected mode and an idle-standby mode according to various embodiments.

FIG. 22 is a component block diagram of a mobile communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The various embodiments provide methods that modify power measurements of frequency bands in order to avoid interference that can occur between transmission and reception activities on a multi-active mobile communication device supporting two subscriptions when a transmission frequency band used by a radio supporting a first subscription interferes with transmissions and reception on a frequency band used by another radio supporting a second subscription. For ease of reference, the term “first subscription” is use to refer to the subscription whose radio will change the operating frequency band used to support the subscription in order to avoid or mitigate interference (e.g., desense) with the operating frequency band of the radio supporting the other (i.e., “second”) subscription. Otherwise, the distinction between the first and second subscriptions is arbitrary.

In the various embodiments, a processor of a multi-subscription communication device, which may have one or more SIMs, may recognize when a frequency band of the first subscription has the potential to interfere with the frequency band of the second subscription by looking up the two frequencies in a data table that identifies incompatible frequency band combinations. Such interference occurs when both subscriptions happen to be active at the same time, which is referred to as coexistence interference. An event of coexistence interference occurs when periodic transmission and/or reception events on both subscriptions are scheduled at the same time, and when the first subscription needs to monitor the network supporting the first subscription or transmit a response while the second subscription is active (e.g., with a voice call). When the processor of multi-subscription communication device recognizes that there is the potential for coexistence events to occur, such as when the frequency band of the first subscription will interfere with the frequency band of the second subscription and the second subscription has started a voice call, the processor may take power measurements of all frequency bands available to support the first subscription. Typically, different frequency bands will be available for communications with cells neighboring the cell on which the first subscription is currently camped. The device processor may determine whether any of the other frequency bands will not interfere (or will interfere less) with the frequency band of the second subscription. If an available non-interfering or less-interference frequency band is identified, the processor may modify the power measurement for the current interfering frequency band to make that frequency band look less preferred for use (e.g., reducing the power measurement value) and modify the power measurement for the identified non-interfering frequency band to make that frequency band look more preferred for use (e.g., increasing the power measurement value).

When the first subscription is active, the modified power measurements may be reported to the network in the ordinary manner, which may induce the network to cause a handover of the first subscription to the identified non-interfering frequency band. When the first subscription is inactive, the modified power measurements may be used by the multi-subscription-multi-active mobile communication device, such as by a modem of the device configured to communicate with a wireless network, to select a cell and frequency band with which to establish service. The modified power measurements may continue to be transmitted to the network while the potential for interference remains, such as the operating state and conditions (e.g., call state of the second subscription, frequency band of the second subscription, etc.) remain unchanged. When there is no longer a potential for interference, the processor may revert to reporting or using actually power measurements for the first subscription.

As used herein, the terms “UE,” “user equipment,” “wireless device,” “mobile communication device,” “multi-subscription-multi-active communication device,” and related terms are used interchangeably and refer to any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices that include a programmable processor, memory, and circuitry for utilizing two or more RF resources/radios to support two or more wireless subscriptions simultaneously. The various aspects may be useful in mobile communication devices, such as smart phones, and so such devices are referred to in the descriptions of various embodiments. However, the embodiments may be useful in any electronic devices, such as a single-SIM, multi-active communication device and a dual-SIM, dual-active (DSDA) communication device, that may individually maintain a plurality of subscriptions that utilize a plurality of separate RF resources.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the term “subscription” is also be used herein as a shorthand reference to the communication service associated with and enabled by the information stored in a particular SIM as the SIM and the communication network, as well as the services and subscriptions supported by that network, correlate to one another.

Various embodiments provide techniques to mitigate coexistence issues in multi-radio devices, where significant in-device coexistence problems can exist between, e.g., the LTE and Industrial Scientific and Medical (ISM) bands (e.g., for BT/WLAN). As explained above, some coexistence issues persist because an eNodeB is not aware of interference on the UE side that is experienced by other radios. According to some embodiments, the UE declares a Radio Link Failure (RLF) and autonomously accesses a new channel or Radio Access Technology (RAT) if there is a coexistence issue on the present channel. The UE may declare a RLF in some examples for the following reasons: 1) UE reception is affected by interference due to coexistence, and 2) the UE transmitter is causing disruptive interference to another radio. In response, the UE may send a message indicating the coexistence issue to the eNodeB while reestablishing connection in the new channel or RAT. The eNodeB becomes aware of the coexistence issue by virtue of having received the message.

The techniques described herein can be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network can implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in portions of the description below.

Single carrier frequency division multiple access (SC-FDMA), which utilizes single carrier modulation and frequency domain equalization is a technique that can be utilized with various aspects described herein. SC-FDMA has similar performance and essentially the same overall complexity as those of an OFDMA system. The SC-FDMA signal has a lower peak-to-average power ratio (PAPR) because of the inherent single-carrier structure of the signals. SC-FDMA has drawn great attention, especially in the uplink communications where lower PAPR greatly benefits the mobile terminal in terms of transmit power efficiency. It is currently a working assumption for an uplink multiple access scheme in 3GPP Long Term Evolution (LTE), or Evolved UTRA.

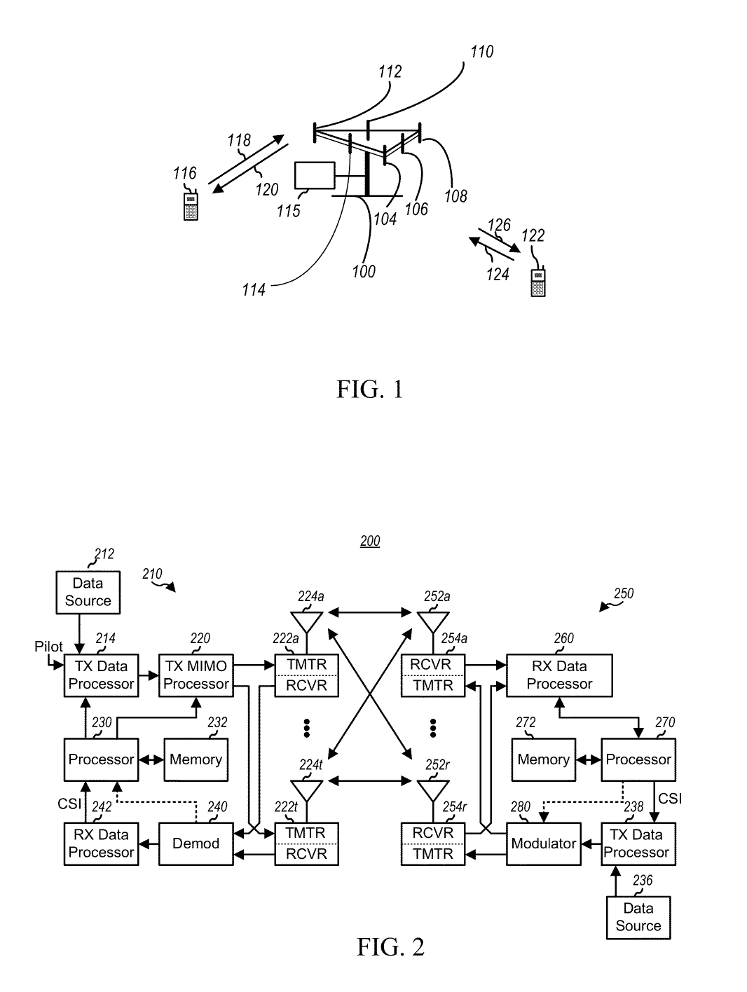

Referring to FIG. 1, a multiple access wireless communication system according to one aspect is illustrated. An evolved Node B 100 (eNodeB) includes a computer 115 that has processing resources and memory resources to manage the LTE communications by allocating resources and parameters, granting/denying requests from user equipment, and/or the like. The eNodeB 100 also has multiple antenna groups, one group including antenna 104 and antenna 106, another group including antenna 108 and antenna 110, and an additional group including antenna 112 and antenna 114. In FIG. 1, only two antennas are shown for each antenna group; however, more or fewer antennas can be utilized for each antenna group. A User Equipment (UE) 116 (also referred to as an Access Terminal (AT)) is in communication with antennas 112 and 114 via a downlink (DL) 120, while antennas 112 and 114 transmit information to the UE 116 over an uplink (UL) 118. A UE 122 is in communication with the antennas 106 and 108, while the antennas 106 and 108 transmit information to the UE 122 over a downlink (DL) 126 and receive information from the UE 122 over an uplink 124. In a frequency division duplex (FDD) system, communication links 118, 120, 124 and 126 can use different frequencies for communication. For example, the downlink 120 can use a different frequency than used by the uplink 118.

Each group of antennas and/or the area in which they are designed to communicate is often referred to as a sector of the eNodeB. In this aspect, respective antenna groups are designed to communicate to UEs in a sector of the areas covered by the eNodeB 100.

In communication over the downlinks 120 and 126, the transmitting antennas of the eNodeB 100 utilize beamforming to improve the signal-to-noise ratio of the uplinks for the different UEs 116 and 122. Also, an eNodeB using beamforming to transmit to UEs scattered randomly through the coverage of the eNodeB causes less interference to UEs in neighboring cells than an eNodeB transmitting through a single antenna to all UEs camped on the eNodeB.

An eNodeB can be a fixed station used for communicating with the terminals and can also be referred to as an access point, base station, or some other terminology. A UE can also be called an access terminal, a wireless communication device, terminal, or some other terminology.

FIG. 2 is a block diagram of an aspect of a transmitter system 210 (also known as an eNodeB—e.g., eNodeB 100 in FIG. 1) and a receiver system 250 (also known as a UE—e.g., UEs 116, 122 in FIG. 1) in a MIMO system 200. With reference to FIGS. 1-2, in some instances, both a UE and an eNodeB each have a transceiver that includes a transmitter system and a receiver system. At the transmitter system 210, traffic data for a number of data streams is provided from a data source 212 to a transmit (TX) data processor 214.

The MIMO system 200 employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, wherein N_{S}<min{N_{T}, N_{R}}. Each of the N_{S} independent channels corresponds to a dimension. The MIMO system 200 can provide improved performance (e.g., higher throughput and/or greater reliability) if the additional dimensionalities created by the multiple transmit and receive antennas are utilized.

The MIMO system 200 supports time division duplex (TDD) and frequency division duplex (FDD) systems. In a TDD system, the uplink and downlink transmissions are on the same frequency region so that the reciprocity principle allows the estimation of the downlink channel from the uplink channel. This enables the eNodeB to extract transmit beamforming gain on the downlink when multiple antennas are available at the eNodeB.

In an aspect, each data stream is transmitted over a respective transmit antenna. The TX data processor 214 formats, codes, and interleaves the traffic data for each data stream based on a particular coding scheme selected for that data stream to provide coded data.

The coded data for each data stream can be multiplexed with pilot data using OFDM techniques. The pilot data is a known data pattern processed in a known manner and can be used at the receiver system to estimate the channel response. The multiplexed pilot and coded data for each data stream is then modulated (e.g., symbol mapped) based on a particular modulation scheme (e.g., BPSK, QSPK, M-PSK, or M-QAM) selected for that data stream to provide modulation symbols. The data rate, coding, and modulation for each data stream can be determined by instructions performed by a processor 230 operating with a memory 232.

The modulation symbols for respective data streams are then provided to a TX MIMO processor 220, which can further process the modulation symbols (e.g., for OFDM). The TX MIMO processor 220 then provides N_{T} modulation symbol streams to N_{T} transmitters (TMTR) 222a through 222t. In certain aspects, the TX MIMO processor 220 applies beamforming weights to the symbols of the data streams and to the antenna from which the symbol is being transmitted.

Each of transmitters 222a-222t receives and processes a respective symbol stream to provide one or more analog signals, and further conditions (e.g., amplifies, filters, and upconverts) the analog signals to provide a modulated signal suitable for transmission over the MIMO channel. N_{T} modulated signals from the transmitters 222a through 222t are then transmitted from N_{T} antennas 224a through 224t, respectively.

At the receiver system 250, the transmitted modulated signals are received by N_{R} antennas 252a through 252r and the received signal from each of antennas 252a-252r is provided to a respective receiver (RCVR) 254a through 254r. Each of the receivers 254a-254r conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from each of the N_{R} receivers 254a-254r based on a particular receiver processing technique to provide N_{R} “detected” symbol streams. The RX data processor 260 then demodulates, deinterleaves, and decodes each detected symbol stream to recover the traffic data for the data stream. The processing by the RX data processor 260 is complementary to the processing performed by the TX MIMO processor 220 and the TX data processor 214 at the transmitter system 210.

A processor 270 (operating with a memory 272) periodically determines which pre-coding matrix to use (discussed below). The processor 270 formulates an uplink message having a matrix index portion and a rank value portion.

The uplink message can include various types of information regarding the communication link and/or the received data stream. The uplink message is then processed by a TX data processor 238, which also receives traffic data for a number of data streams from a data source 236, modulated by a modulator 280, conditioned by transmitters 254a through 254r, and transmitted back to the transmitter system 210.

At the transmitter system 210, the modulated signals from the receiver system 250 are received by antennas 224a-224t, conditioned by one or more receivers 222a-222t, demodulated by a demodulator 240, and processed by an RX data processor 242 to extract the uplink message transmitted by the receiver system 250. The processor 230 then determines which pre-coding matrix to use for determining the beamforming weights, then processes the extracted message.

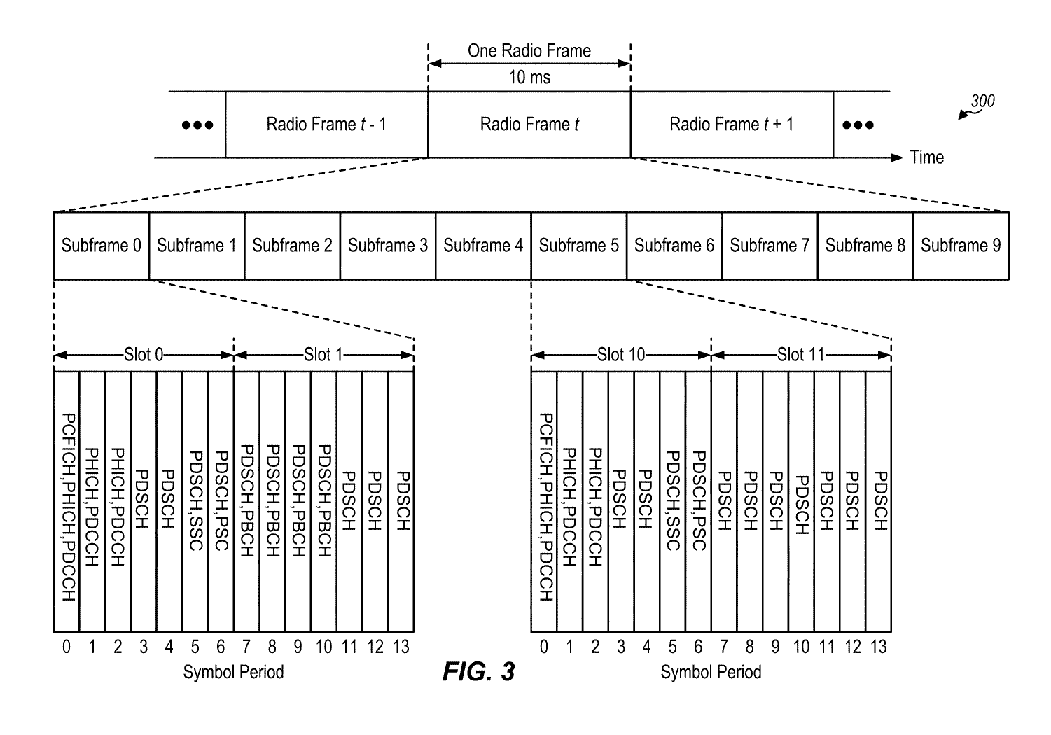

FIG. 3 is a block diagram 300 conceptually illustrating an exemplary frame structure in downlink Long Term Evolution (LTE) communications. With reference to FIGS. 1-3, the transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 3) or 6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNodeB may send a Primary Synchronization Signal (PSS) and a Secondary Synchronization Signal (SSS) for each cell in the eNodeB. The PSS and SSS may be sent in symbol periods 6 and 5, respectively, in each of subframes 0 and 5 of each radio frame with the normal cyclic prefix (see, e.g., FIG. 3). The synchronization signals may be used by UEs for cell detection and acquisition. The eNodeB may send a Physical Broadcast Channel (PBCH) in symbol periods 0 to 3 in slot 1 of subframe 0. The PBCH may carry certain system information.

The eNodeB may send a Cell-specific Reference Signal (CRS) for each cell in the eNodeB. The CRS may be sent in symbols 0, 1, and 4 of each slot in case of the normal cyclic prefix, and in symbols 0, 1, and 3 of each slot in case of the extended cyclic prefix. The CRS may be used by UEs for coherent demodulation of physical channels, timing and frequency tracking, Radio Link Monitoring (RLM), Reference Signal Received Power (RSRP), and Reference Signal Received Quality (RSRQ) measurements, etc.

The eNodeB may send a Physical Control Format Indicator Channel (PCFICH) in the first symbol period of each subframe, as seen in FIG. 3. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 3, M=3. The eNodeB may send a Physical HARQ Indicator Channel (PHICH) and a Physical Downlink Control Channel (PDCCH) in the first M symbol periods of each subframe. The PDCCH and PHICH are also included in the first three symbol periods in the block diagram 300. The PHICH may carry information to support Hybrid Automatic Repeat Request (HARQ). The PDCCH may carry information on resource allocation for UEs and control information for downlink channels. The eNodeB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNodeB may send the PSS, SSS and PBCH in the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to specific UEs in specific portions of the system bandwidth. The eNodeB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNodeB may send the PDCCH to the UE in any of the combinations that the UE will search.

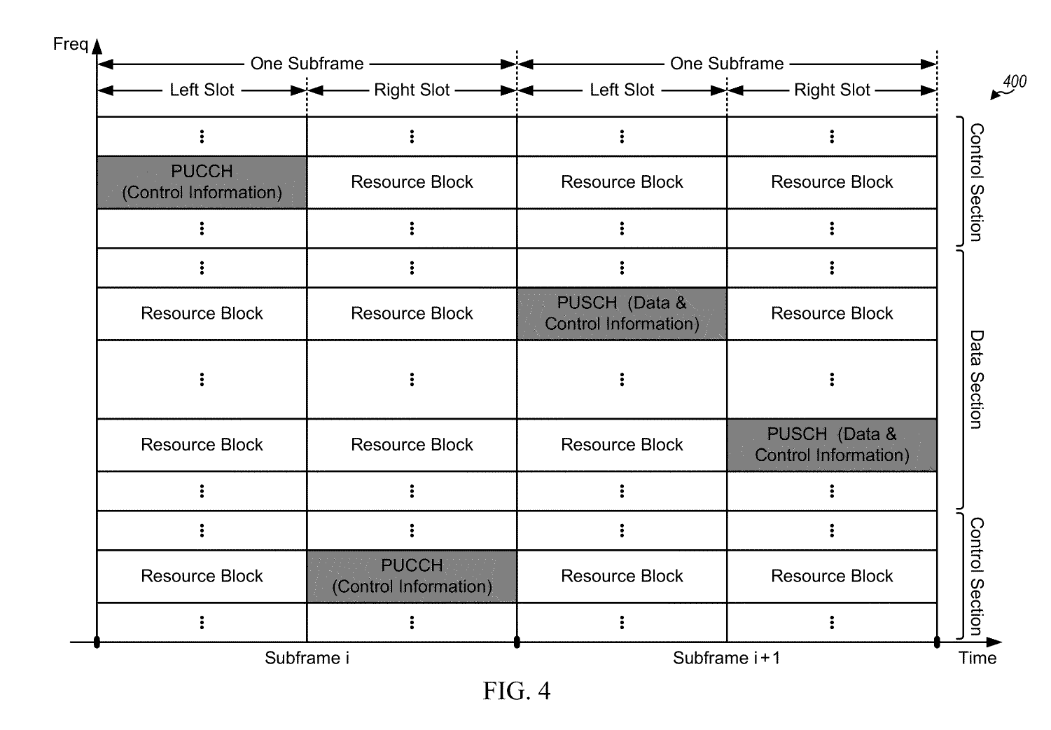

FIG. 4 is a block diagram 400 conceptually illustrating an exemplary frame structure in uplink Long Term Evolution (LTE) communications. With reference to FIGS. 1-4, the available Resource Blocks (RBs) for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 4 results in the data section including contiguous subcarriers, which may allow a single UE to be assigned all of the contiguous subcarriers in the data section.

A UE may be assigned resource blocks in the control section to transmit control information to an eNodeB. The UE may also be assigned resource blocks in the data section to transmit data to the eNodeB. The UE may transmit control information in a Physical Uplink Control Channel (PUCCH) on the assigned resource blocks in the control section. The UE may transmit only data or both data and control information in a Physical Uplink Shared Channel (PUSCH) on the assigned resource blocks in the data section. An uplink transmission may span both slots of a subframe and may hop across frequency as shown in the block diagram 400.

The PSS, SSS, CRS, PBCH, PUCCH and PUSCH in LTE are described in 3GPP TS 36.211, entitled “Evolved Universal Terrestrial Radio Access (E-UTRA); Physical Channels and Modulation,” which is publicly available.

In an aspect, described herein are systems and methods for providing support within a wireless communication environment, such as a 3GPP LTE environment or the like, to facilitate multi-radio coexistence solutions.

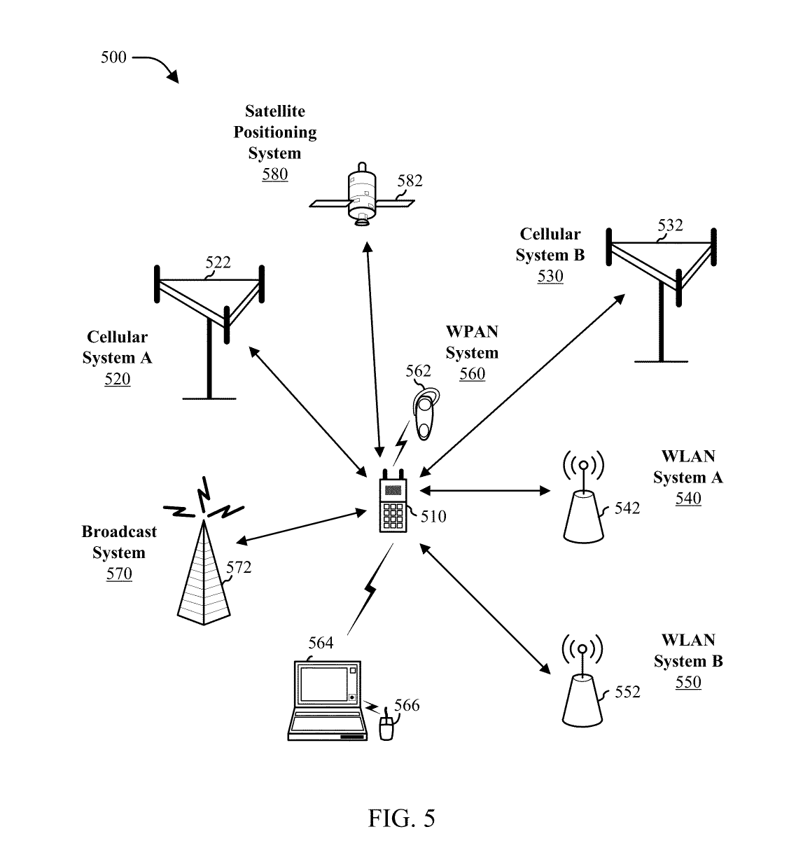

Referring now to FIG. 5, illustrated is an example wireless communication environment 500 in which various aspects described herein can function. With reference to FIGS. 1-5, the wireless communication environment 500 can include a wireless device 510, which can be capable of communicating with multiple communication systems. These systems can include, for example, one or more cellular systems 520 and/or 530, one or more WLAN systems 540 and/or 550, one or more wireless personal area network (WPAN) systems 560, one or more broadcast systems 570, one or more satellite positioning systems 580, other systems not shown in the wireless communication environment 500, or any combination thereof. It should be appreciated that in the following description the terms “network” and “system” are often used interchangeably.

The cellular systems 520 and 530 can each be a CDMA, TDMA, FDMA, OFDMA, Single Carrier FDMA (SC-FDMA), or other suitable system. A CDMA system can implement a radio technology such as Universal Terrestrial Radio Access (UTRA), CDMA2000, etc. UTRA includes Wideband CDMA (WCDMA) and other variants of CDMA. Moreover, CDMA2000 covers IS-2000 (CDMA2000 1X), IS-95 and IS-856 (HRPD) standards. A TDMA system can implement a radio technology such as Global System for Mobile Communications (GSM), Digital Advanced Mobile Phone System (D-AMPS), etc. An OFDMA system can implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3^{rd} Generation Partnership Project” (3GPP). CDMA2000 and UMB are described in documents from an organization named “3^{rd} Generation Partnership Project 2” (3GPP2). In an aspect, the cellular system 520 can include a number of base stations 522, which can support bi-directional communication for wireless devices within their coverage. Similarly, the cellular system 530 can include a number of base stations 532 that can support bi-directional communication for wireless devices within their coverage.

WLAN systems 540 and 550 can respectively implement radio technologies such as IEEE 802.11 (WiFi), Hiperlan, etc. The WLAN system 540 can include one or more access points 542 that can support bi-directional communication. Similarly, the WLAN system 550 can include one or more access points 552 that can support bi-directional communication. The WPAN system 560 can implement a radio technology such as Bluetooth (BT), IEEE 802.15, etc. Further, the WPAN system 560 can support bi-directional communication for various devices such as the wireless device 510, a headset 562, a computer 564, a mouse 566, or the like.

The broadcast system 570 can be a television (TV) broadcast system, a frequency modulation (FM) broadcast system, a digital broadcast system, etc. A digital broadcast system can implement a radio technology such as MediaFLO™, Digital Video Broadcasting for Handhelds (DVB-H), Integrated Services Digital Broadcasting for Terrestrial Television Broadcasting (ISDB-T), or the like. Further, the broadcast system 570 can include one or more broadcast stations 572 that can support one-way communication.

The satellite positioning system 580 can be the United States Global Positioning System (GPS), the European Galileo system, the Russian GLONASS system, the Quasi-Zenith Satellite System (QZSS) over Japan, the Indian Regional Navigational Satellite System (IRNSS) over India, the Beidou system over China, and/or any other suitable system. Further, the satellite positioning system 580 can include a number of satellites 582 that transmit signals for position determination.

In an aspect, the wireless device 510 can be stationary or mobile and can also be referred to as a user equipment (UE), a mobile station, a mobile equipment, a terminal, an access terminal, a subscriber unit, a station, etc. The wireless device 510 can be cellular phone, a personal digital assistance (PDA), a wireless modem, a handheld device, a laptop computer, a cordless phone, a wireless local loop (WLL) station, etc. In addition, the wireless device 510 can engage in two-way communication with the cellular system 520 and/or 530, the WLAN system 540 and/or 550, devices with the WPAN system 560, and/or any other suitable systems(s) and/or devices(s). The wireless device 510 can additionally or alternatively receive signals from the broadcast system 570 and/or satellite positioning system 580. In general, it can be appreciated that the wireless device 510 can communicate with any number of systems at any given moment. Also, the wireless device 510 may experience coexistence issues among various constituent radio devices of the wireless device that operate at the same time. Accordingly, device 510 includes a coexistence manager (CxM, not shown) that has a functional module to detect and mitigate coexistence issues, as explained further below.

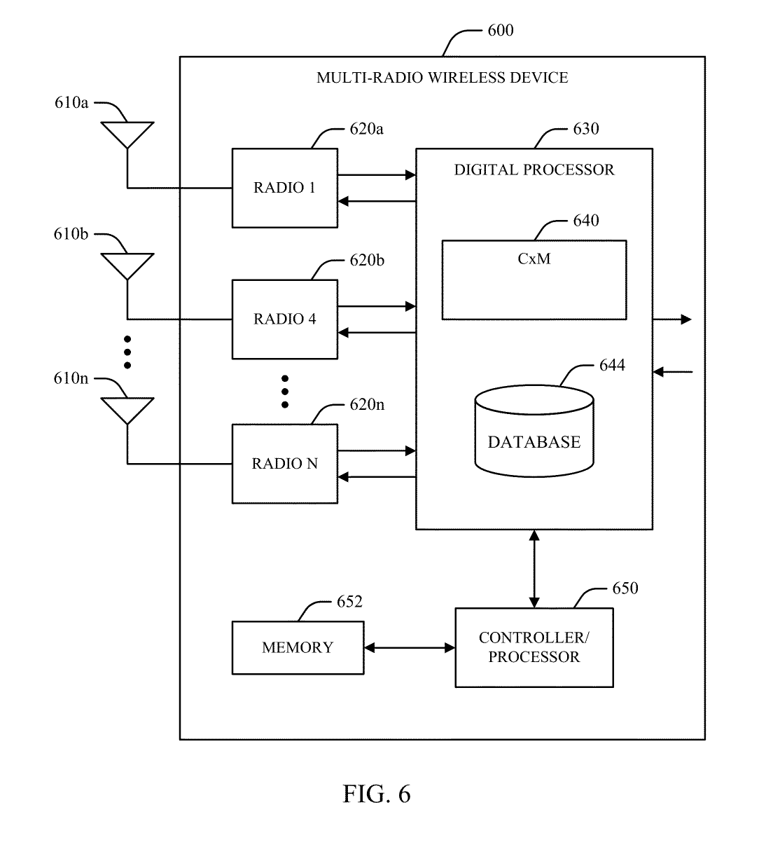

Turning next to FIG. 6, a block diagram is provided that illustrates an example design for a multi-subscription-multi-active (i.e., multi-radio) mobile communication device 600 (which, for example, may correspond to the UEs 116, 122 in FIG. 1) and may be used as an implementation of the radio 510 of FIG. 5. With reference to FIGS. 1-6, the multi-subscription-multi-active mobile communication device 600 can include N radios 620a through 620n, which can be coupled to N antennas 610a through 610n, respectively, where N can be any integer value. It should be appreciated, however, that respective radios 620 can be coupled to any number of antennas 610 and that multiple radios 620 can also share a given antenna 610.

In general, a radio (e.g., each of the radios 620a-620n) can be a unit that radiates or emits energy in an electromagnetic spectrum, receives energy in an electromagnetic spectrum, or generates energy that propagates via conductive means. By way of example, each of the radios 620a-620n can be a unit that transmits a signal to a system or a device or a unit that receives signals from a system or device. Accordingly, it can be appreciated that each of the radios 620a-620n can be utilized to support wireless communication. In another example, each of the radios 620a-620n can also be a unit (e.g., a screen on a computer, a circuit board, etc.) that emits noise, which can impact the performance of other radios. Accordingly, it can be further appreciated that each of the radios 620a-620n can also be a unit that emits noise and interference without supporting wireless communication.

In an aspect, respective radios 620a-620n can support communication with one or more systems. Multiple radios 620a-620n can additionally or alternatively be used for a given system, e.g., to transmit or receive on different frequency bands (e.g., cellular and PCS bands).

In another aspect, a digital processor 630 can be coupled to the radios 620a through 620n and can perform various functions, such as processing for data being transmitted or received via the radios 620a-620n. The processing for each of radios 620a-620n can be dependent on the radio technology supported by that radio and can include encryption, encoding, modulation, etc., for a transmitter; demodulation, decoding, decryption, etc., for a receiver, or the like. In one example, the digital processor 630 can include a CxM 640 that can control operation of the radios 620a-620n in order to improve the performance of the wireless device 600 as generally described herein. The CxM 640 can have access to a database 644, which can store information used to control the operation of the radios 620. As explained further below, the CxM 640 can be adapted for a variety of techniques to decrease interference between the radios. In one example, the CxM 640 requests a measurement gap pattern or DRX cycle that allows an ISM radio to communicate during periods of LTE inactivity.

For simplicity, digital processor 630 is shown in FIG. 6 as a single processor. However, it should be appreciated that the digital processor 630 can include any number of processors, controllers, memories, etc. In one example, a controller/processor 650 can direct the operation of various units within the multi-subscription-multi-active mobile communication device 600. Additionally or alternatively, a memory 652 can store program codes and data for the wireless device 600. The digital processor 630, controller/processor 650, and memory 652 can be implemented on one or more integrated circuits (ICs), application specific integrated circuits (ASICs), etc. By way of a specific, non-limiting example, the digital processor 630 can be implemented on a Mobile Station Modem (MSM) ASIC.

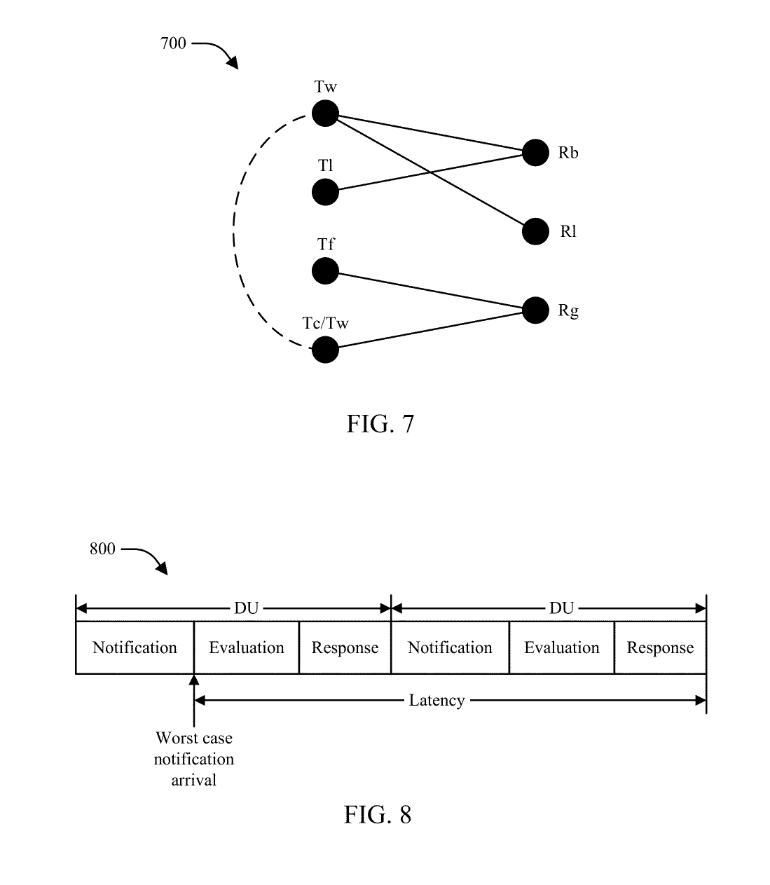

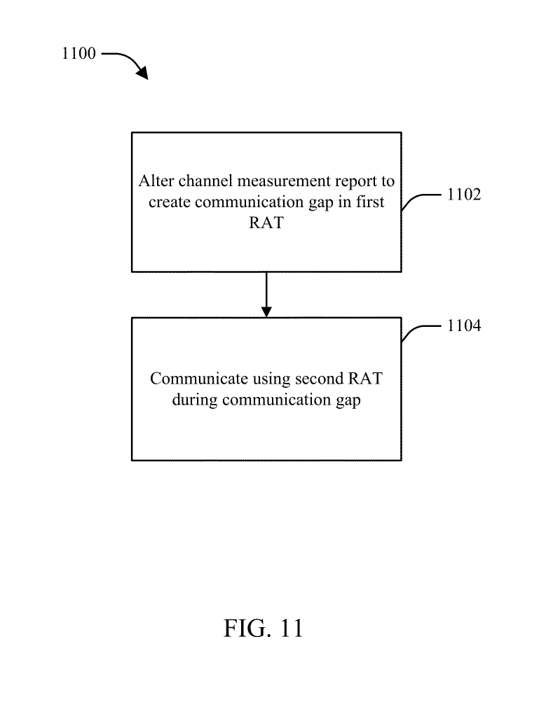

In an aspect, the CxM 640 can manage operation of respective radios 620a-620n utilized by the multi-subscription-multi-active mobile communication device 600 in order to avoid interference and/or other performance degradation associated with collisions between respective radios 620. CxM 640 may perform one or more processes, such as those illustrated in FIG. 11. By way of further illustration, a graph 700 in FIG. 7 represents respective potential collisions between seven example radios in a given decision period. With reference to FIGS. 1-7, in the example shown in the graph 700, the seven radios include a WLAN transmitter (Tw), an LTE transmitter (Tl), an FM transmitter (Tf), a GSM/WCDMA transmitter (Tc/Tw), an LTE receiver (Rl), a Bluetooth receiver (Rb), and a GPS receiver (Rg). The four transmitters are represented by four nodes on the left side of the graph 700. The three receivers are represented by three nodes on the right side of the graph 700.

A potential collision between a transmitter and a receiver is represented on the graph 700 by a branch connecting the node for the transmitter and the node for the receiver. Accordingly, in the example shown in the graph 700, collisions may exist between (1) the WLAN transmitter (Tw) and the Bluetooth receiver (Rb); (2) the LTE transmitter (Tl) and the Bluetooth receiver (Rb); (3) the WLAN transmitter (Tw) and the LTE receiver (Rl); (4) the FM transmitter (Tf) and the GPS receiver (Rg); (5) a WLAN transmitter (Tw), a GSM/WCDMA transmitter (Tc/Tw), and a GPS receiver (Rg).

In one aspect, an example CxM 640 can operate in time in a manner such as that shown by diagram 800 in FIG. 8. With reference to FIGS. 1-8, as the diagram 800 illustrates, a timeline for CxM operation can be divided into Decision Units (DUs), which can be any suitable uniform or non-uniform length (e.g., 100 μs) where notifications are processed, and a response phase (e.g., 20 μs) where commands are provided to various radios 620 and/or other operations are performed based on actions taken in the evaluation phase. In one example, the timeline shown in the diagram 800 can have a latency parameter defined by a worst case operation of the timeline, e.g., the timing of a response in the case that a notification is obtained from a given radio immediately following termination of the notification phase in a given DU.

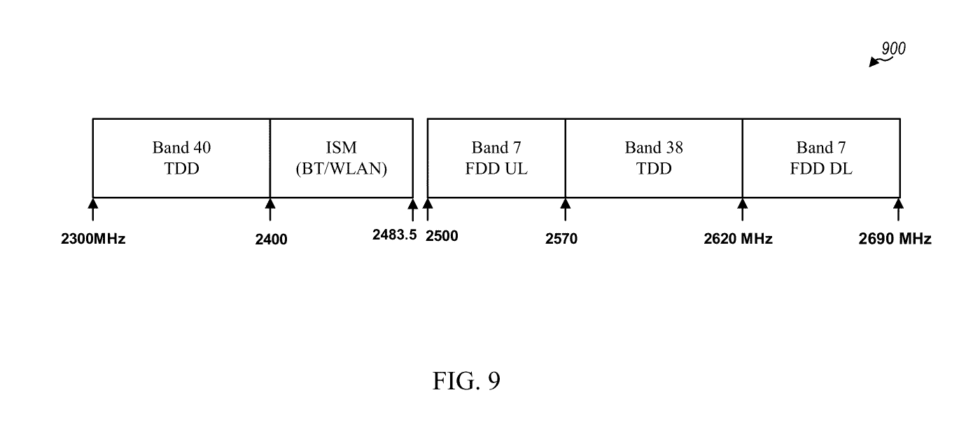

As shown in a block diagram 900 illustrated in FIG. 9, Long Term Evolution (LTE) in band 7 (for frequency division duplex (FDD) uplink), band 40 (for time division duplex (TDD) communication), and band 38 (for TDD downlink) is adjacent to the 2.4 GHz Industrial Scientific and Medical (ISM) band used by Bluetooth (BT) and Wireless Local Area Network (WLAN) technologies. With reference to FIGS. 1-9, frequency planning for these bands is such that there is limited or no guard band permitting traditional filtering solutions to avoid interference at adjacent frequencies. For example, a 20 MHz guard band exists between ISM and band 7, but no guard band exists between ISM and band 40.

To be compliant with appropriate standards, communication devices operating over a particular band are to be operable over the entire specified frequency range. For example, in order to be LTE compliant, a mobile station/user equipment should be able to communicate across the entirety of both band 40 (2300-2400 MHz) and band 7 (2500-2570 MHz) as defined by the 3rd Generation Partnership Project (3GPP). Without a sufficient guard band, devices employ filters that overlap into other bands causing band interference. Because band 40 filters are 100 MHz wide to cover the entire band, the rollover from those filters crosses over into the ISM band causing interference. Similarly, ISM devices that use the entirety of the ISM band (e.g., from 2401 through approximately 2480 MHz) will employ filters that rollover into the neighboring band 40 and band 7 and may cause interference.

In-device coexistence problems can exist with respect to a UE between resources such as, for example, LTE and ISM bands (e.g., for Bluetooth/WLAN). In current LTE implementations, any interference issues to LTE are reflected in the downlink measurements (e.g., Reference Signal Received Quality (RSRQ) metrics, etc.) reported by a UE and/or the downlink error rate which the eNodeB can use to make inter-frequency or inter-RAT handoff decisions to, e.g., move LTE to a channel or RAT with no coexistence issues. However, it can be appreciated that these existing techniques will not work if, for example, the LTE uplink is causing interference to Bluetooth/WLAN but the LTE downlink does not see any interference from Bluetooth/WLAN. More particularly, even if the UE autonomously moves itself to another channel on the uplink, the eNodeB can in some cases handover the UE back to the problematic channel for load balancing purposes. In any case, it can be appreciated that existing techniques do not facilitate use of the bandwidth of the problematic channel in the most efficient way.

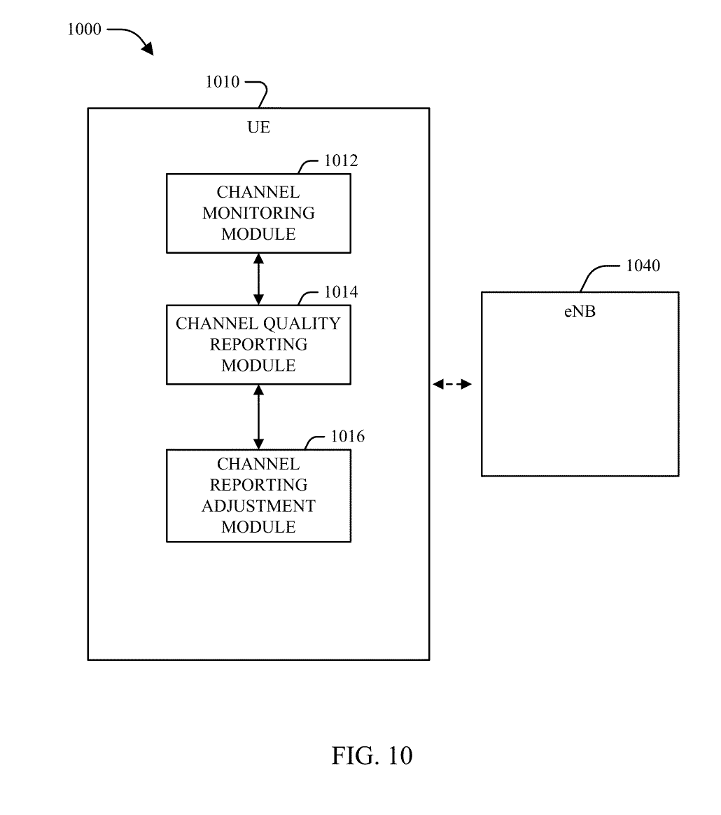

Turning now to FIG. 10, a block diagram of a system 1000 for providing support within a wireless communication environment for multi-radio coexistence management is illustrated. With reference to FIGS. 1-10, in an aspect, the system 1000 can include one or more UEs 1010 and/or eNodeBs 1040, which can engage in uplink and/or downlink communications, and/or any other suitable communication with each other and/or any other entities in the system 1000. In one example, the UE 1010 and/or eNodeB 1040 can be operable to communicate using a variety resources, including frequency channels and sub-bands, some of which can potentially be colliding with other radio resources (e.g., a broadband radio such as an LTE modem). Thus, the UE 1010 can utilize various techniques for managing coexistence between multiple radios utilized by the UE 1010, as generally described herein.

To mitigate at least the above shortcomings, the UE 1010 can utilize respective features described herein and illustrated by the system 1000 to facilitate support for multi-radio coexistence within the UE 1010. For example, a channel monitoring module 1012, a channel quality reporting module 1014, and a channel reporting adjustment module 1016 may be implemented. The channel monitoring module 1012 monitors the performance of communication channels for potential interference issues. The channel quality reporting module 1014 reports on the quality of communication channels. The channel reporting adjustment module 1016 may adjust the reporting on the quality of communication channels using the methods described below. The various modules 1012-1016 may, in some examples, be implemented as part of a coexistence manager such as the CxM 640 (FIG. 6). The various modules 1012-1016 and others may be configured to implement the embodiments discussed herein.

From the perspective of a UE/mobile device, LTE is, by design, a receiving system. If transmission by another technology such as an Industrial Scientific and Medical (ISM) radio like Bluetooth interferes with LTE reception, the coexistence manager may stop the interfering technology to accommodate LTE. One parameter a UE has to measure LTE downlink (DL) receiving performance is the channel quality indicator (CQI). The CQI value may be used and manipulated by a UE/coexistence manager to manage coexistence between multiple radios on a UE.

In one aspect of the present disclosure, the value of CQI may be set to zero, thereby tricking an eNB to believe a UE is out of range for one communication technology (such as an LTE) in order to create gaps which may be used for communication by other technologies (such as an ISM radio). In another aspect of the present disclosure, the value of CQI may be reduced. Coexistence interference that fluctuates over time may cause a mismatch in link performance. The CQI may be filtered over a period of time and an average CQI reported, in order to compensate. An alternative may be to always report a CQI with the interference. In another aspect of the present disclosure, CQI may be boosted above what it should be to include an error.

Setting CQI to zero may be used by a coexistence manager to create time gaps where LTE is rendered inactive, thereby allowing the coexistence manager to allocate channel resources to another interfering technology, including Bluetooth (BT) operating in Advanced Audio Distribution Profile (A2DP) mode (audio mode) and wireless local area network (WLAN). In order to signal an evolved NodeB (eNodeB) to not schedule the user, and thereby create a gap during which the UE is not expected to process LTE downlink signals, the UE can send a CQI=0 value to the eNodeB. The eNodeB will interpret CQI=0 as an out of range value which the eNodeB will take to indicate that the UE is not in a position to receive downlink grants. Such an indication would assist in creating an LTE downlink gap. The UE sends a CQI=0 before the LTE-OFF interval to create the gap and sends the correct CQI value just before the LTE-ON interval. The resulting gap may then be used for communication by an interfering technology. During the LTE-ON interval the LTE reception monitors downlink subframes for grants sent by the eNB. During the LTE-OFF interval, LTE receptions are not expecting grants, so LTE does not monitor downlink sub-frames these resources may be assigned to other technologies.

Reducing CQI is another technique that may be used by a coexistence manager. In normal operation, CQI accounts for the coexistence interference in the power estimate. If the loss in throughput (due to a lower CQI value) is reasonable, a coexistence manager may rely on the CQI to create a compensating coexistence mitigation scheme. That is, if the loss is already accounted for, the rate will be set appropriately.

If interference is inconsistent or bursty (i.e., varies over time), at certain times the CQI may indicate no interference even though interference does exist at the time of transmission, thereby causing a mismatch in link performance and potentially causing a “spiral of death” which results in a continuing drop in performance potentially resulting in a dropped call (see below). To avoid this situation, the UE may average the CQI over a period of time (e.g., multiple subframes) to capture the interference caused by coexistence. The time of averaging may correspond to the time of HARQ (hybrid automatic repeat request), meaning the time spent to transmit a packet. Interference may be averaged over a period of time (x ms). The UE may assume the same interference will be seen over the next x milliseconds. Alternatively, the UE may be conservative and send the CQI with the coexistence interference (i.e., the CQI value representing the worst performance) to the eNodeB.

According to an aspect of the present disclosure, boosting CQI is another technique available to a coexistence manager. Due to coexistence issues, the coexistence manager may compromise LTE reception by allowing another interfering technology to transmit. By adjusting the CQI value reported to an eNodeB, a coexistence manager may allow a UE to achieve a better LTE downlink throughput rate than would otherwise be available by reporting actual CQI, so long as “spiral of death” effects discussed below are avoided.

Typically, the eNodeB may run an outer loop for rate control to adjust the CQI value to account for changes in transmission conditions from when the CQI value was reported to the eNodeB by a UE to the time of the next downlink grant. The eNodeB outer loop tracks the packet error rate over a period of time. The outer loop may add a CQIbackoff value to the reported CQI. The outer loop continually runs to adjust the CQIbackoff to an amount just sufficient for packet decoding. For example, if a particular packet does not decode, the CQIbackoff increases by some value Δup (backoff increase). If a packet does decode, the CQIbackoff decreases by some value Δdown (backoff decrease). The values Δup and Δdown may be chosen to keep a desired downlink packet error rate at a steady state. If downlink sub-frames to a UE are denied because of coexistence, the modulation coding scheme (MCS) allocated to the UE in downlink communications would decrease. If a coexistence manager is actively compromising/denying downlink sub-frames with a rate higher than used by the outer loop, the MCS assigned to the UE will continue to drop to compensate until hitting the minimum MCS defined by the air interface standard, e.g., 3GPP specification. This process is known as a “spiral of death” (SoD). The spiral of death may cause severe throughput loss and potential call drop.

The spiral of death may occur in the following manner. Assume an outer loop packet error rate target of 20%. If a coexistence manager compromises 30% of LTE downlink subframes, those denial rates create an error rate unacceptable to the outer loop packet error rate, and the MCS will be unable to lower sufficiently to achieve successful operation. Because the outer loop will never converge (i.e., achieve an acceptable packet error rate), the spiral of death occurs.

In another example, the spiral of death may be avoided. Assume an outer loop packet error rate of 40% on the first transmission. If a coexistence manager is compromising 30% of LTE downlink subframes, because that denial rate is less than the outer loop packet error rate, the outer loop will drop the MCS to a point where the packet error rate is only 10%, such that the combined rates of error of the MCS and denial of LTE reach the targeted 40%. Thus the MCS and coexistence LTE denial will converge to achieve equilibrium and successful operation. In this example, no spiral of death effects will be seen.

The UE/coexistence manager may adjust the CQI reporting to avoid the spiral of death and manage coexistence issues. For example, if the UE reports a higher than actual CQI to the eNodeB, the eNodeB will apply an extra backoff due to the spiral of death process. Thus, the total CQI remains almost unchanged. The UE, however, typically does not know the values of Δs applied by the eNodeB and whether or not the spiral of death is occurring. Accordingly, the proper CQI value should somehow be estimated.

A series of equations may be used to determine CQI reporting sufficient to avoid spiral of death issues when creating transmission gaps for coexistence management. Define:
y: the denial rate for LTE downlink
x: the packet error rate used by eNodeB outer loop
Cr(n): reported CQI at time n
Ct(n): true CQI at time n for subframes with good quality
Co(n): CQI determined by eNodeB at time n (accounting for the eNodeB backoff value).
   Co(n) can be determined by mapping the downlink decoded data rate at time n to a CQI value using the CQI table in air interface standard, (e.g., the 3GPP specification) and a number of resource blocks (RBs) allocated. The actual decoded data rate can be the average rate over one CQI report interval.

In the absence of coexistence interference, the backoff, B(n), applied by the outer loop is:

B(n)=Σᵢ₌₁₋ₙgi, where
gi=Δup with probability x or Δdown with probability (1−x).
   In the absence of coexistence interference, the outer loop will converge when:

$$Δ up \cdot x = Δ down \cdot ( 1 - x ) , that is Δ down = ( \frac{x}{1 - x} ) \cdot Δ up$$

The eNodeB CQI, Co(n), is calculated as:

Co(n)=Cr(n)−B1−B2(n)

where B1 is a backoff accumulated by the outer loop due to time variation in the channel, and B2(n) is the extra backoff added by the outer loop when the targeted packet error rate is not met due to downlink denials. If the coexistence manager denies y % of the LTE downlink sub-frames where y>x:

$$E ( B 2 ( n ) ) = n ( \frac{y}{1 - x} ) Δ up , where E ( z ) is the expected value of z$$

the backoff will increase over time causing the spiral of death. To avoid this, the UE may report a true CQI plus error:

$$\begin{matrix}Cr ( n ) = Ct ( n ) + [ Cr ( n - 1 ) - Co ( n - 1 ) ] \\ = Ct ( n ) + B 1 + B 2 ( n - 1 )\end{matrix}$$

$$hence , \\ \begin{matrix}Co ( n ) = Ct ( n ) - B 2 ( n ) + B 2 ( n - 1 ) \\ = Ct ( n ) - v , where v has a mean of ( \frac{y}{1 - x} ) Δ up\end{matrix}$$

In this manner, the likely backoff to be applied by the outer loop at the eNodeB is compensated for in the CQI reported by the UE. Thus, the loss in throughput is limited and does not grow with n, thereby avoiding the spiral of death while adjusting CQI values to allow for coexistence management.

As shown in a method 1100 illustrated in FIG. 11, a UE may alter a channel measurement report to create a communication gap in a first radio access technology (RAT), as shown in block 1102. With reference to FIGS. 1-11, a UE may communicate using a second RAT during the created communication gap, as shown in block 1104.

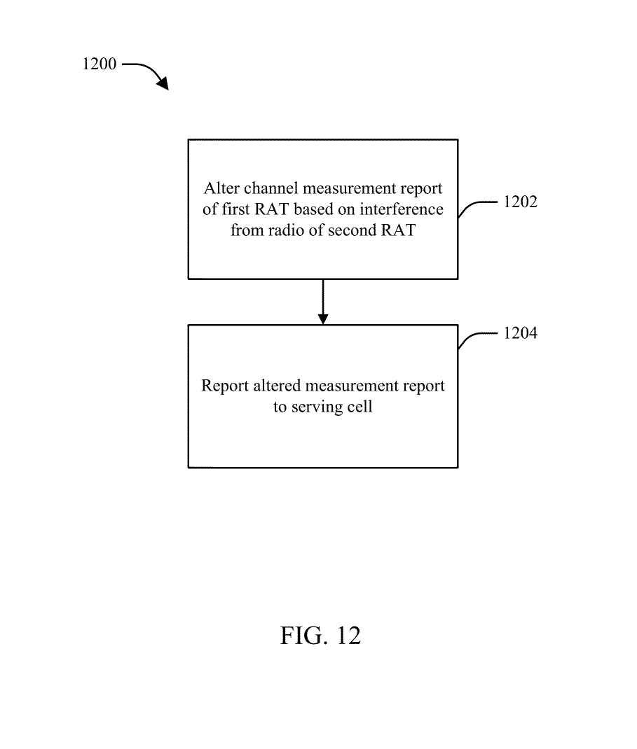

As shown in a method 1200 illustrated in FIG. 12, a UE may alter a channel measurement report of a first radio access technology (RAT) based on interference from a radio of a second RAT, as shown in block 1202. With reference to FIGS. 1-12, a UE may report the altered channel measurement report to a serving cell, as shown in block 1202.

A UE may comprise means for altering a channel measurement report to create a communication gap in a first radio access technology. In one aspect, the aforementioned means may be the channel reporting adjustment module 1016, the coexistence manager 640, the memory 272, and/or the processor 270 configured to perform the functions recited by the aforementioned means. The UE may also comprise means for communicating using a second RAT during the created communication gap. In one aspect, the aforementioned means may be the antennae 252a-252r, the coexistence manager 640, the memory 272, and/or the processor 270 configured to perform the functions recited by the aforementioned means. In another aspect, the aforementioned means may be a module or any apparatus configured to perform the functions recited by the aforementioned means.

A UE may comprise means for altering a channel measurement report of a first radio access technology (RAT) based on interference from a radio of a second RAT. In one aspect, the aforementioned means may be the channel reporting adjustment module 1016, the receive data processor 260, the coexistence manager 640, the memory 272, and/or the processor 270 configured to perform the functions recited by the aforementioned means. The UE may also comprise means for reporting the altered channel measurement report to a serving cell. In one aspect, the aforementioned means may be the channel quality reporting module 1014, the antennae 252, the memory 272, and/or the processor 270 configured to perform the functions recited by the aforementioned means. In another aspect, the aforementioned means may be a module or any apparatus configured to perform the functions recited by the aforementioned means.

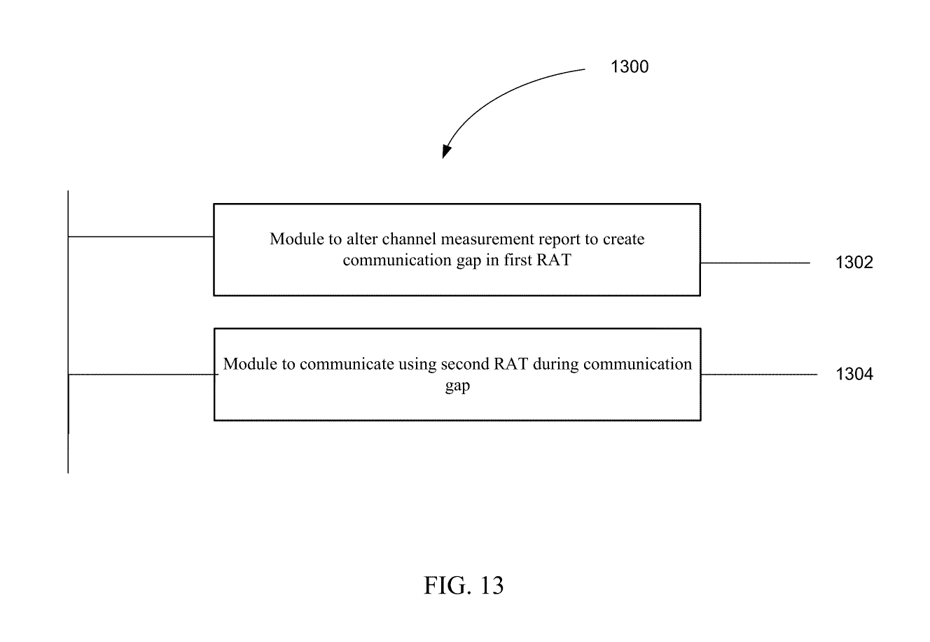

FIG. 13 shows a design of an apparatus 1300 for a UE. With reference to FIGS. 1-13, the apparatus 1300 includes a module 1302 to alter a channel measurement report to create a communication gap in a first radio access technology (RAT). The apparatus also includes a module 1304 to communicate using a second RAT during the created communication gap. The modules in FIG. 13 may be processors, electronics devices, hardware devices, electronics components, logical circuits, memories, software codes, firmware codes, etc., or any combination thereof.

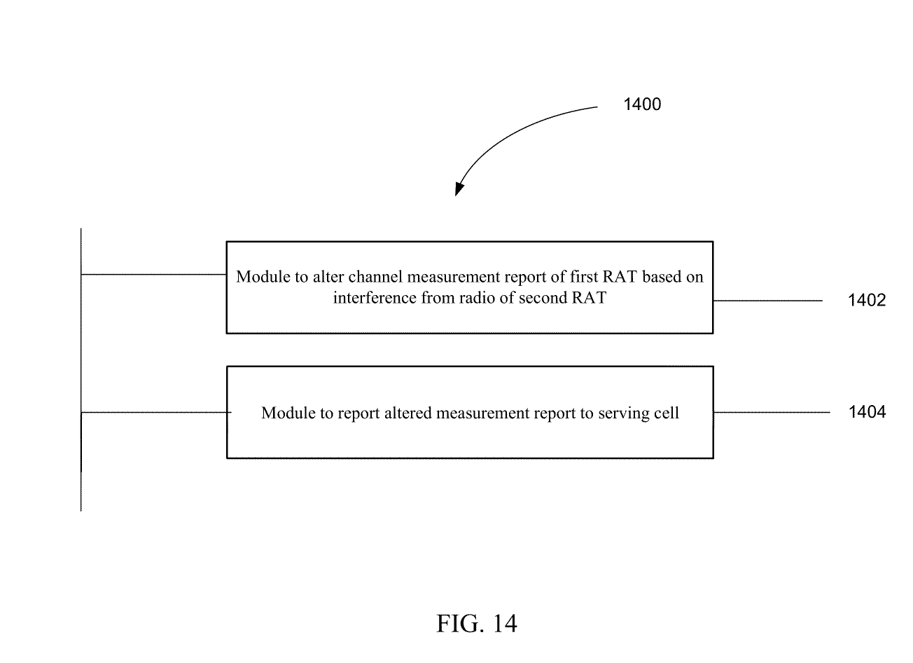

FIG. 14 shows a design of an apparatus 1400 for a UE. With reference to FIGS. 1-14, the apparatus 1400 includes a module 1402 to alter a channel measurement report of a first radio access technology (RAT) based on interference from a radio of a second RAT. The apparatus also includes a module 1404 to report the altered channel measurement report to a serving cell. The modules in FIG. 14 may be processors, electronics devices, hardware devices, electronics components, logical circuits, memories, software codes, firmware codes, etc., or any combination thereof.

As described, because a multi-subscription-multi-active communication device has a plurality of separate radios, referred to as RF resources, each subscription on the multi-subscription-multi-active communication device may use the RF resource used by the subscription to communicate with associated mobile network at any time. Each RF resource includes a chain of circuitry from a modem through the radio and including the antenna, which is referred to as an RF resource chain. As a result, in certain band-channel combinations of operation, the simultaneous use of the RF resources may cause one or more RF resources to desensitize or interfere with the ability of the other RF resources to operate normally because of the proximity of the antennas of the RF resource chains included in the multi-subscription-multi-active communication device.

For example, a dual-subscription-dual-active communication device may suffer from intra-device interference when an aggressor first subscription is attempting to transmit while a second subscription in the dual-subscription-dual-active communication device is simultaneously attempting to receive transmissions and the frequency band used the first subscription will interfere with the frequency band used by the second subscription. Thus, intra-device interference occurs when the frequency bands used by the two subscriptions will interfere with each other and both subscriptions are simultaneously transmitting or receiving. During such an event of coexistence interference, the aggressor subscription's transmissions may impair the victim subscription's ability to receive transmissions. This interference may be in the form of blocking interference, harmonics, intermodulation, and other noises and distortion received by the victim subscription. Such interference may significantly degrade the victim's receiver sensitivity, page receptions, and Short Message Service (SMS) reception. These effects may also result in a reduced network capacity of the multi-subscription-multi-active communication device.

Currently, several solutions are implemented on conventional multi-subscription-multi-active communication devices to mitigate victim subscription de-sense. In some solutions, a multi-subscription-multi-active communication device configures the aggressor subscription to reduce or zero the transmit power while the victim subscription is receiving transmissions (sometimes referred to as implementing transmit (“Tx”) blanking) in order to reduce or eliminate the victim subscription's de-sense. While such current solutions are effective in reducing the victim subscription's de-sense, the improvement to the victim subscription's reception performance is often at the expense of the aggressor subscription's performance. Current solutions that utilize Tx blanking incur a cost on the link-level performance of the aggressor subscription and/or impact the aggressor subscription's uplink throughput because the total amount of data the aggressor subscription is able to send to the network is diminished because some transmissions are lost (i.e., “blanked”) due to low or zeroed transmit power. Specifically, by implementing Tx blanking, some (or all) of the information included in the data blocks sent via the aggressor subscription to the network may be lost, increasing the error rate (e.g., the block error rate or “BLER”) and dropped packets in data streams transmitted to the network of the aggressor subscription.

Typically, multiple bands/channels may be available to a subscription operating on a multi-subscription-multi-active communication device. For example, while the radio supporting a subscription is camped on a given network cell using the frequency band assigned to the subscription, there will usually be service available from other nearby cells on their frequency bands. Thus, other conventional solutions leverage a subscription's access to multiple frequency bands to avoid coexistence interference by configuring the subscription to receive service from a frequency band that does not interfere with other frequency bands. However, current solutions either involve directly notifying the network of a subscription's interfering bands—requiring additional signaling and communications between the multi-subscription-multi-active communication device and the network—or removing the subscription's interfering frequency bands from a list of bands reported to the network, which may limit the MSMA communication device's overall communication capabilities.

The various embodiments that may be implemented on a mobile communication device (e.g., a multi-subscription-multi-active communication device) provide methods of mitigating or otherwise managing the effects of de-sense on a victim subscription's performance as a result of an aggressor subscription's use of a frequency band that interferes with the victim subscription's frequency band during simultaneous radio (i.e., transmission and/or reception) activities. Specifically, in various embodiments, a processor of the mobile communication device may generate modified power measurements for frequency bands of a first subscription (i.e., an aggressor or victim subscription) when coexistence interference will occur with a second subscription and may utilize those modified power measurements to cause the first subscription to switch to a frequency band that does not experience/cause coexistence interference (i.e., a “non-interfering frequency band”) or causes less interference (i.e., a “less-interfering frequency band”) with the frequency band used by the second subscription. Using such modified power measurements may cause the network to force the multi-subscription communication device to hand-over to a neighboring cell in order to use a non-interfering or less-interfering frequency band. In other words, a processor implementing the various embodiments generates power measurement values that differ from the actual measurements, such as to indicate less or more received power than actually measured, in order to cause the mobile communication device or the network to select or switch to a non-interfering or less-interfering frequency band or cell site.

For ease of reference, the generated power measurement that is different from the measured value is referred to herein as a “modified power measurement.” As a result, the device processor may avoid or mitigate the impact of coexistence interference between the first subscription and a second subscription without limiting the capabilities of the multi-subscription-multi-active mobile communication device and without requiring additional or non-standard communications typically required to avoid interfering frequency bands. The terms “modified power measurements” and “modifying power measurements” encompass any of a variety of changes or manipulations that may be made to power measurements of frequency bands in order to make a frequency look less or more preferred for use. Modifying power measurements may include negatively biasing (e.g., reducing the power measurement value of an interfering frequency band) and positively biasing (e.g., increasing the power measurement value of a non-interfering or less-interfering frequency band) the actual power measurement. Modifying power measurements may further include linearly biasing, non-linearly biasing, zeroing and maximizing a power measurement. Additionally, in various embodiments one, a few or all of the power measurements of the first subscription may be modified.

In various embodiments, the activities of subscriptions may change during the ordinary course of operating on a multi-subscription-multi-active mobile communication device, such as when a call ends on one subscription and begins on the other subscription, or when the radios supporting the subscriptions perform handovers to new cells as the device moves. Thus, an aggressor subscription at a first time may become a victim subscription at a second time, and the victim subscription at the first time may similarly become an aggressor subscription at a second or third time. Thus, while various embodiments may occasionally be described with reference to an aggressor subscription and a victim subscription, the subscriptions are referred to generally as a “first subscription” that will generate modified power measurements in order to cause actions that will avoid interfering with the frequency of a “second subscription” to reflect that the subscriptions' roles in the various embodiments. For example, at moment the device processor may generate modified power measurements for a GSM subscription (treating it as the “first subscription”) because an LTE subscription is on an active call (treating it as the “second subscription”), and a few minutes later generate modified power measurements for the LTE subscription (treating it as the “first subscription”) because the GSM subscription is on an active call (treating it as the “second subscription”). Thus, the references to first and second subscriptions in this application are arbitrary and solely for identifying the subscription for which power measurements may be modified.

In some embodiments, in response to detecting that coexistence interference is occurring or about to occur between a first subscription and a second subscription, a processor of the multi-subscription-multi-active mobile communication device (e.g., a coexistence manager or CxM) may generate modified power measurements for one or more of the first subscription's available frequency bands. For example, the device processor may generate modified Reference Signal Receive Power (“RSRP”) measurements and/or Reference Signal Received Quality (“RSRQ”) measurements.

In some embodiments, the device processor may generate modified power measurements by applying a negative bias to the power measurements of the first subscription's one or more interfering frequency bands to cause the measurements of those bands to appear degraded relative to the measurements of one or more non-interfering frequency bands available to the first subscription. In some embodiments, the device processor may alternatively (or additionally) apply a positive bias to the power measurements of the one or more non-interfering frequency bands available to the first subscription in order to cause the power measurements of the one or more non-interfering frequency bands to appear better than power measurements associated with the first subscription's interfering frequency bands.

In some embodiments, the device processor may calculate a negative bias for modifying one or more of the first subscription's interfering frequency bands based on a measure of the degree of coexistence interference associated with those interfering frequency bands. For example, the device processor may determine the extent to which an interfering frequency band of the first subscription de-senses a frequency band of the second subscription and may calculate a negative bias to apply to the power measurements of the interfering frequency band based on that determined de-sense severity. Thus, in such embodiments, the device processor may generate modified power measurements for interfering frequencies such that power measurements for interfering frequency bands associated with a higher level of interference/de-sense may be artificially degraded more than power measurements of less-interfering or non-interfering frequency bands.

In some embodiments, particularly when no non-interfering frequency band is available to the first subscription, the processor may select a least-interfering frequency band for preferential use, and apply a positive bias (i.e., increase) to generate the modified power measurement for that selected less-interfering frequency band even though it will cause some coexistence interference. In some embodiments, a positive bias may applied to an interfering frequency band only when the estimated interference is below an acceptable threshold value, otherwise other methods of coexistence management may be employed.

In some embodiments, when the first subscription is operating in an “idle mode” in which the first subscription performs idle-standby-mode operations (e.g., power measurements, paging reception, etc.), the device processor may generate modified power measurements for one or more of the first subscription's available frequency bands (e.g., by applying negative and/or positive biases to actual power measurements) and may provide those modified power measurements to components on the mobile communication device that are typically responsible for performing cell selection/reselection (sometimes referred to as “cell selection/reselection components”). In other words, the device processor may generate and utilize the modified power measurements internally on the multi-subscription-multi-active mobile communication device to cause the first subscription to perform cell selection/reselection to another cell based at least in part on the modified power measurements. In such embodiments, the cell selection/reselection components on the multi-subscription-multi-active mobile communication device may reference the modified power measurements when determining whether to instruct the first subscription to switch to another frequency band/cell. In some embodiments, when the device processor applies a negative bias to one or more of the first subscription's interfering frequency bands and/or a positive bias to the first subscription's non-interfering frequency bands, the cell selection/reselection components may instruct the first subscription to move from an interfering frequency band to a non-interfering frequency band that appears to provide better service due to the artificially low power measurements of the interfering frequency band and/or the artificially high power measurements of the non-interfering frequency bands.

When the first subscription is operating in a “connected mode,” such as when the first subscription is actively communicating with the first subscription's network (e.g., during a voice or data call), the device processor may send the modified power measurements for one or more of the first subscription's available frequency bands to the first subscription's network (e.g., to a base station or enhanced Node B). As described, the modified power measurements falsely indicate that the first subscription's interfering frequency bands provide reduced/poor service in comparison to the non-interfering frequency bands available to the first subscription whose modified power measurements falsely indicate that those frequency bands will provide better service. Thus, in response to receiving the modified power measurements from the multi-subscription-multi-active mobile communication device, the first subscription's network may perform standard operations to instruct the first subscription to move from an interfering frequency band to a non-interfering frequency band. In other words, the network may cause the first subscription to handover to a non-interfering frequency band because the modified power measurements sent from the multi-subscription-multi-active mobile communication device “tricks” the network into determining that the interfering frequency bands are unable to provide adequate service or that non-interfering bands provide better service.

While a non-interfering frequency band of the first subscription may be a frequency band that does not interfere with the frequency band of the second subscription, in some embodiments, a non-interfering frequency band may be any frequency band that causes/experiences interference that is below a certain threshold of desense. For example, a frequency band that is mildly interfering may be deemed acceptable or a “non-interfering” frequency band because the interference associated with the frequency band is below an interference threshold. Thus, in such embodiments, another frequency band may be deemed an “interfering” frequency band when that that frequency band causes interference that satisfies (e.g., is equal to or less than) the interference threshold.

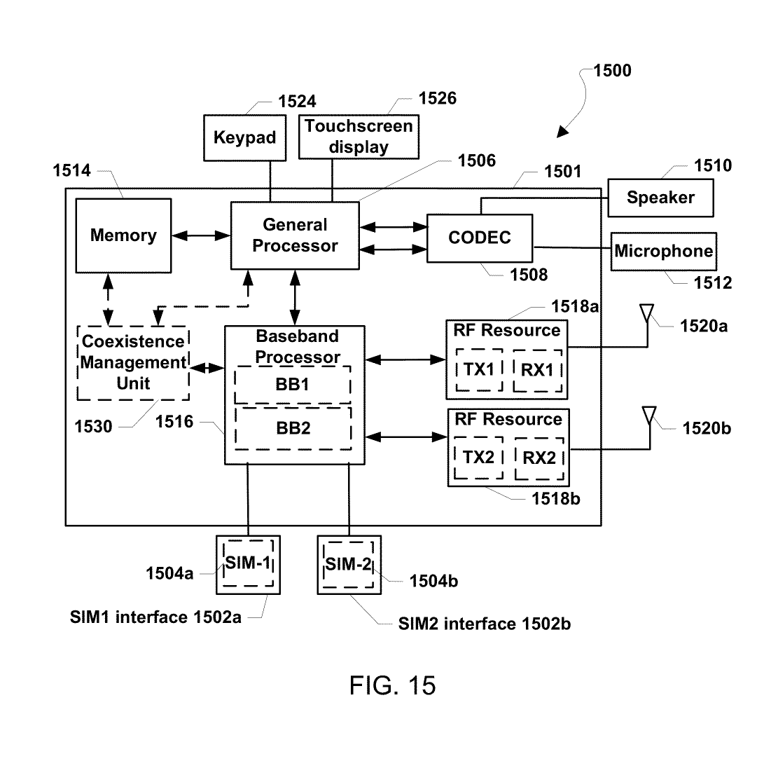

FIG. 15 is a functional block diagram of a mobile communication device 1500 suitable for implementing various embodiments. According to various embodiments, the multi-subscription-multi-active mobile communication device 1500 may be similar to one or more of the mobile communication devices (or UEs) 116, 122, 250, 510, 600, 1010 as described with reference to FIGS. 1, 2, 5, 6, and 10.

With reference to FIGS. 1-15, the multi-subscription-multi-active mobile communication device 1500 may include a first SIM interface 1502a, which may receive a first identity module SIM-1 1504a that is associated with a first subscription. The multi-subscription-multi-active mobile communication device 1500 may also include a second SIM interface 1502b, which may receive a second identity module SIM-2 1504b that is associated with a second subscription.

A SIM in various embodiments may be a Universal Integrated Circuit Card (UICC) that is configured with SIM and/or USIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM, and I/O circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home PLMN (HPLMN) code, etc.) to indicate the SIM card network operator provider. An Integrated Circuit Card Identity (ICCID) SIM serial number is printed on the SIM card for identification. However, a SIM may be implemented within a portion of memory of the mobile communication device 1500 (e.g., memory 1514), and thus need not be a separate or removable circuit, chip or card.

The multi-subscription-multi-active mobile communication device 1500 may include at least one controller, such as a general processor 1506. In some embodiments, the general processor 1506 may be similar to the processor 270 and/or the controller/processor 650. The general processor 1506 may be coupled to a coder/decoder (CODEC) 1508, and the CODEC 1508 may in turn be coupled to a speaker 1510 and a microphone 1512. The general processor 1506 may also be coupled to the memory 1514, which may be similar to the memory 272 and/or the memory 652. The memory 1514 may be a non-transitory computer readable storage medium that stores processor-executable instructions. For example, the instructions may include routing communication data relating to the first or second subscription though a corresponding baseband-RF resource chain.

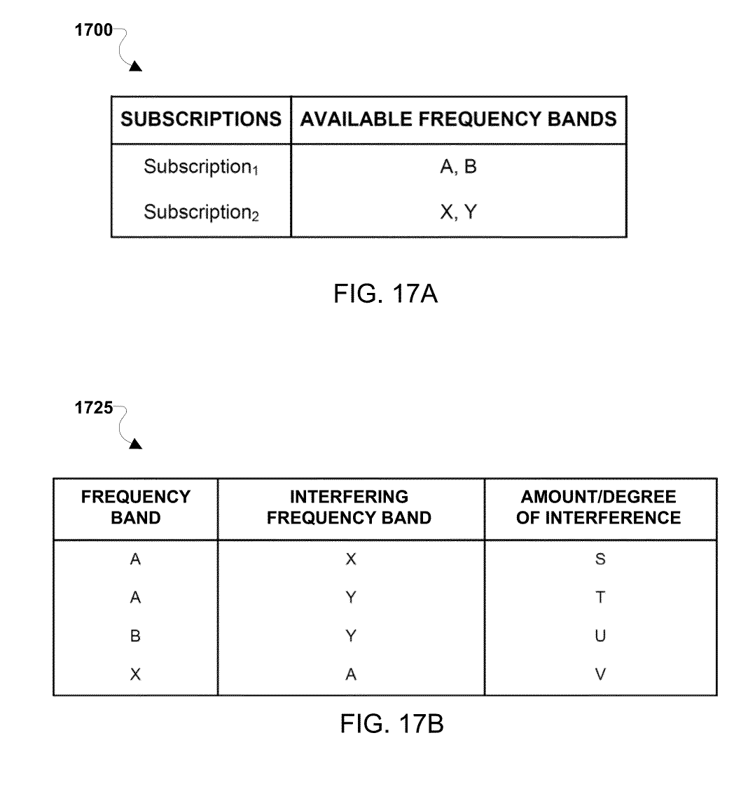

The memory 1514 may store an operating system (OS), as well as user application software and executable instructions. The memory 1514 may also store application data, such as an array data structure. In some embodiments, the memory 1514 may also store one or more look-up tables, lists, or various other data structures that may be referenced to determine whether a frequency band of a first subscription interferes with (or is interfered by) a frequency band of a second subscription (see, e.g., FIGS. 17A-17B).

The general processor 1506 and the memory 1514 may each be coupled to at least one baseband modem processor 1516, which, in some embodiments, may be similar to the digital processor 630. Each SIM coupled to the mobile communication device 1500 (e.g., the SIM-1 1504a and the SIM-2 1504b) may be associated with a baseband-RF resource chain. The baseband-RF resource chain may include the baseband modem processor 1516, which may perform baseband/modem functions for communicating with/controlling a radio access technology (RAT), and may include one or more amplifiers and radios, referred to generally herein as RF resources (e.g., RF resources 1518a, 1518b). In some embodiments, baseband-RF resource chains may share the baseband modem processor 1516 (i.e., a single device that performs baseband/modem functions for all SIMs on the mobile communication device 1500). In other embodiments, each baseband-RF resource chain may include physically or logically separate baseband processors (e.g., BB1, BB2).

In some embodiments, the RF resources 1518a, 1518b may be associated with different SIMs/subscriptions. For example, a first subscription to an LTE network may be associated with the RF resource 1518a, and a second subscription to a GSM network may be associated with the RF resource 1518b. The RF resources 1518a, 1518b may each be transceivers that perform transmit/receive functions on behalf of their respective subscriptions/SIMs. The RF resources 1518a, 1518b may also include separate transmit and receive circuitry, or may include a transceiver that combines transmitter and receiver functions. The RF resources 1518a, 1518b may each be coupled to a wireless antenna (e.g., a first wireless antenna 1520a or a second wireless antenna 1520b). The RF resources 1518a, 1518b may also be coupled to the baseband modem processor 1516.

In some embodiments, the general processor 1506, the memory 1514, the baseband processor(s) 1516, and the RF resources 1518a, 1518b may be included in the multi-subscription-multi-active mobile communication device 1500 as a system-on-chip 1501. In some embodiments, the first and second SIMs 1504a, 1504b and their corresponding interfaces 1502a, 1502b may be external to the system-on-chip. Further, various input and output devices may be coupled to components on the system-on-chip, such as interfaces or controllers. Example user input components suitable for use in the mobile communication device 1500 may include, but are not limited to, a keypad 1524, a touchscreen display 1526, and the microphone 1512.

In some embodiments, the keypad 1524, the touchscreen display 1526, the microphone 1512, or a combination thereof, may perform the function of receiving a request to initiate an outgoing call. For example, the touchscreen display 1526 may receive a selection of a contact from a contact list or receive a telephone number. In another example, either or both of the touchscreen display 1526 and the microphone 1512 may perform the function of receiving a request to initiate an outgoing call. For example, the touchscreen display 1526 may receive a selection of a contact from a contact list or to receive a telephone number. As another example, the request to initiate the outgoing call may be in the form of a voice command received via the microphone 1512. Interfaces may be provided between the various software modules and functions in the mobile communication device 1500 to enable communication between them, as is known in the art.

Functioning together, the two SIMs 1504a, 1504b, the baseband modem processor 1516, the RF resources 1518a, 1518b, and the wireless antennas 1520a, 1520b may constitute two or more RATs. For example, a SIM, baseband processor, and RF resource may be configured to support a GSM RAT, an LTE RAT, and/or a WCDMA RAT. More RATs may be supported on the multi-subscription-multi-active mobile communication device 1500 by adding more SIM cards, SIM interfaces, RF resources, and/or antennae for connecting to additional mobile networks.

The multi-subscription-multi-active mobile communication device 1500 may include a coexistence management unit 1530 configured to manage and/or schedule the subscriptions' utilization of the RF resources 1518a, 1518b, such as by adjusting the power measurements of a first subscription during coexistence interference between the first subscription and a second subscription in order to cause the first subscription to move from an interfering frequency band to a non-interfering frequency band. In some embodiments, the coexistence management unit 1530 may be similar to the CxM 640. In some embodiments, the coexistence management unit 1530 may be implemented within the general processor 1506. In some embodiments, the coexistence management unit 1530 may be implemented as a separate hardware component (i.e., separate from the general processor 1506). In some embodiments, the coexistence management unit 1530 may be implemented as a software application stored within the memory 1514 and executed by the general processor 1506.

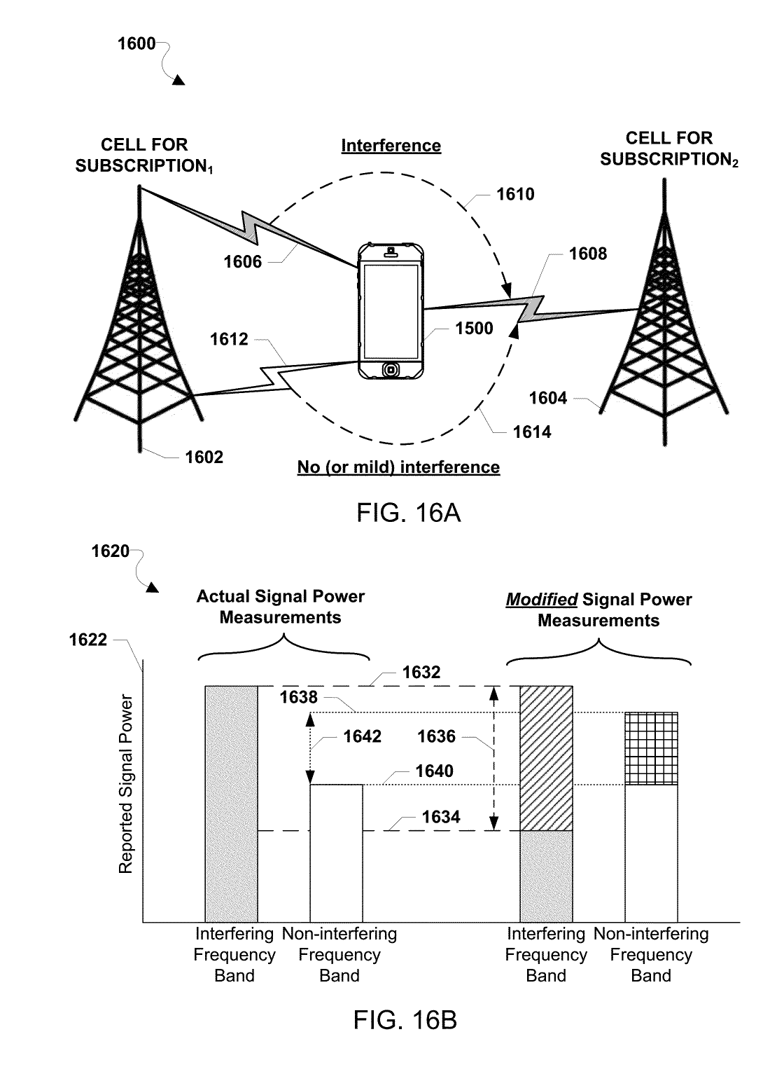

FIG. 16A illustrates a communication system 1600 in which coexistence interference occurs between a first subscription and a second subscription on a mobile communication device (e.g., the mobile communication device 1500 of FIG. 15). With reference to FIGS. 1-16A, the multi-subscription-multi-active mobile communication device 1500 may communicate with a cell 1602 in the first subscription's network via a frequency band, such as a first frequency band 1606 or a second frequency band 1612. In some embodiments, the multi-subscription-multi-active mobile communication device 1500 may simultaneously support communications with a cell 1604 in the second subscription's network via a third frequency band 1608.

As described, coexistence interference between two frequency bands may occur on the multi-subscription-multi-active mobile communication device 1500 when transmissions sent via a frequency band of the first subscription interferes with the ability of second subscription to receive communications from the cell 1604 via the frequency band 1608 (or vice versa). For example, the signals received via the frequency band 1608 for the second subscription may become corrupted and difficult or impossible to decode as a result of de-sense or interference 1610 caused by the first frequency band 1606.

Because coexistence interference between a frequency band of the first subscription and a frequency band of the second subscription may severely degrade the performance of the second subscription, the multi-subscription-multi-active mobile communication device 1500 may avoid such coexistence interference by determining that there is a likelihood of coexistence interference occurring between the first frequency band 1606 and the third frequency band 1608 and by causing the first subscription to move to another frequency band that does not interfere with the third frequency band 1608 or that interferes with the third frequency band 1608 less than the first frequency band 1606. For example, the mobile communication device 1500 may determine that moving the first subscription from the first frequency band 1606 to the second frequency band 1612 would avoid the interference 1610 as the third frequency band 1608 may not experience interference from the second frequency band 1612 (represented by the dashed arrow 1614) or may experience comparatively mild interference, thereby improving the second subscription's performance.

In various embodiments, in order to cause the first subscription to move from the first frequency band 1606 (i.e., an interfering frequency band) to the second frequency band 1612 (i.e., a non-interfering frequency band), a device processor of the multi-subscription-multi-active mobile communication device 1500 may modify (e.g., artificially adjust or bias) the power measurements associated with the frequency bands 1606, 1612 to make the first frequency band 1606 appear worse than the second frequency band 1612.

FIG. 16B is a graph 1622 illustrating actual and modified signal power measurements for an interfering frequency band (e.g., the first frequency band 1606 of FIG. 16A) and a non-interfering frequency band (e.g., the second frequency band 1612 of FIG. 16A) of a first subscription of a multi-subscription-multi-active mobile communication device (e.g., the multi-subscription-multi-active mobile communication device 1500 of FIG. 15). With reference to FIGS. 1-16B and as described, a device processor of the multi-subscription-multi-active mobile communication device may modify or bias the actual power measurements of the frequency bands available to the first subscription to cause the first subscription's interfering frequency bands to appear worse than the first subscription's non-interfering frequency bands, thereby increasing the likelihood that the first subscription will be moved from an interfering frequency band to a non-interfering frequency band.

In some embodiments, the device processor may initially take actual power measurements of the first subscription's available frequency bands, such as by measuring the RSRP and/or RSRQ values associated with those frequency bands. In the example illustrated in the graph 1620, the device processor may take actual power measurements 1632, 1640 for an interfering frequency band and a non-interfering frequency band, respectively, available to the first subscription. In this example, the interfering frequency band has an actual power measurement 1632 that is higher than an actual power measurement 1640 of the non-interfering frequency band. As such, under ordinary circumstances, the mobile communication device and/or the first subscription's network may attempt to configure the first subscription to receive service via the interfering frequency band as the interfering frequency band has a relatively higher signal power than the non-interfering frequency band (i.e., a likelihood of providing better service). However, as described, the interfering frequency band may cause the first subscription to experience impaired service (e.g., the first subscription is a victim of interference from another frequency band) and/or may cause a second subscription to experience impaired service (e.g., the second subscription is a victim of the first subscription's interference).

To avoid this interference, the device processor implementing the various embodiments may artificially adjust or bias the interfering frequency band's actual power measurement 1632 and/or the non-interfering frequency band's actual power measurement 1640 so that the non-interfering frequency band appears to be better, thereby increasing the likelihood that the first subscription will be moved from the interfering frequency band to the non-interfering frequency band. For example, the device processor may apply a negative bias 1636 to the actual power measurement 1632 of the interfering frequency band. By applying the negative bias 1636, the device processor may generate an adjusted or modified power measurement 1634 that is below the actual signal power measurement 1640 of the non-interfering frequency band. A negative bias may be a constant (or step function) subtraction, a linear bias, or a non-linear or proportional bias. Continuing this example, when the device processor reports the modified power measurement 1634 of the interfering frequency band and the actual signal power measurement 1640 to the first subscription's network, the network may send the first subscription instructions to move from the interfering frequency to the non-interfering frequency band because the non-interfering frequency band appears to have a higher power measurement.

In some embodiments, the negative bias 1636 may be a value that, when applied to the interfering frequency band's actual power measurement 1632, results in a modified signal power measurement that is below the actual signal power measurement 1640 of the non-interfering frequency or below a maximum signal power threshold.

In some embodiments, the negative bias 1636 applied to the power measurement of an interfering frequency band may be depend on or be associated with an amount of interference attributable to the interfering frequency band (see FIGS. 17A-17B). For example, in instances in which the interfering frequency band is associated with a small amount of interference (e.g., the interfering frequency band is slightly affected by or slightly affects a frequency band of the second subscription), the negative bias 1636 may be small, resulting in a modified power measurement that is not significantly less than the interfering frequency's actual power measurement. By applying a negative modification (bias) in proportion with the amount of interference associated with the interfering frequency, the device processor may ensure that the first subscription receives service from the best possible frequency band after considering the effects of interference.

In some embodiments, the device processor may additionally (or alternatively) apply a positive modification (bias) 1642 to (or otherwise increase) the actual signal power measurement 1640 of the non-interfering frequency band or bands to generate a modified power measurement that makes the non-interfering frequency band(s) to appear to offer better service than the interfering frequency band. The device processor may calculate the positive bias 1642 based on the amount of interference associated with the interference frequency band. A positive bias may be a constant (or step function) addition, a linear bias, or a non-linear or proportional bias. In some embodiments, the positive bias 1642 may be based on a minimum power measurement threshold to ensure that the non-interfering frequency band appears to have a higher signal power measurement than the interfering frequency band.

For ease of description, the graph 1620 includes only one interfering frequency band and one non-interfering frequency band of the first subscription. However, the subscriptions may be associated with multiple interfering frequency bands and multiple non-interfering frequency bands, and the device processor may perform operations similar to those described above for each frequency band available to the first subscription. For example, the device processor may apply a negative bias to one, some or all of the first subscription's interfering frequency bands to ensure that the first subscription's one or more non-interfering frequency bands appear comparatively better for establishing communication links than interfering frequency bands.

In some embodiments, the device processor may apply a separate or specific bias to generate modified power measurements for each interfering and/or non-interfering frequency band. For example, to ensure that the reported signal power of each of the interfering frequency bands is sufficiently decreased, the device processor may artificially lower the actual signal power of the interfering frequency bands such that each interfering frequency band's modified signal power is below a maximum signal power threshold.

In some embodiments, the device processor may determine the extent to which each interfering frequency band affects a non-interfering frequency band, such as by referencing a data table as described. Based on that determination, the device processor may apply a separate negative bias to each interfering frequency band in proportion to the extent to which each interfering frequency band is interfering or will interfere with (or is interfered by) another frequency band. In such embodiments, the interfering frequency bands associated with the highest amount of interference may have the largest negative biases applied to their signal power measurements. In some embodiments, the device processor may apply these interference-specific negative biases to effectively “rank” the interfering frequency bands by their respective amount of interference, thereby ensuring that the interfering bands associated with less interference appear to be capable of offering better service than interfering frequency bands associated with more interference.

In some embodiments, the device processor may apply a negative bias to an interfering frequency band's RSRP power measurement. In instances in which the first subscription's interfering frequency band is a victim of de-sense (i.e., a “victim scenario”), the device processor may apply a negative bias to the interfering frequency band that is proportional to the difference of a reception de-sense threshold (“RX_{TH}”) associated with the first subscription and a received signal strength indication (“RSSI”). As a non-limiting example, when a raw measure of the RSSI (“RSSI_{RAW}”) is less than RX_{TH}, the device processor may calculate a negative bias based on the following equation:

negative bias=(RX_{TH}+Δ_{Scaling}−RSSI_{RAW})

where the term Δ_{scaling} is a scaling factor based on the bandwidth difference between RX_{TH} and RSSI_{RAW} measured in decibels (dB).

In such embodiments, the modified RSRP measurement for a victim-only interfering frequency band (either for communicating with a neighboring cell or for the serving cell of the first subscription) may be represented by the following equation:

$${RSRP}_{m} = {RSRP}_{RAW} - {α}_{PV} \times min [ {MPL}_{p} , max [ 0 , {RX}_{TH} + 10 {log}_{10} \frac{{N}_{RB , raw}}{{N}_{RB , TH}} - {RSSI}_{RAW} ] ] ,$$

where RSRPₘ is the modified RSRP measurement in dB, RSRP_{RAW} is the actual RSRP measurement in dB, α_{PV} is a configurable scaling factor of the negative bias (e.g., α_{PV}=1), MBLₚ is a configurable RSRP bias limit (e.g., 15 dB) used to prevent unbounded negative bias that may deteriorate the mobile communication device's mobility (e.g., blind handovers or dropped calls), N_{RB, raw} and N_{RB, TH} are the number of resource blocks (RB) of the raw measurements and the Rx de-sense threshold RX_{TH}, respectively, and 10 log₁₀ of (N_{RB, raw}/N_{RB, TH}) is a scaling back factor from RX_{TH} to RSSI_{RAW}. In some embodiments, RX_{TH} may be measured in dB based on a 20 MHz bandwidth and full RB allocation (i.e., N_{RB, TH}=100), the actual measurement bandwidth of a serving cell may depend on network deployment and configuration (e.g., N_{RB, raw} for a serving cell may equal 6, 15, 25, 50, 75, or 100), and neighboring cell measurements may be based on narrow-band measurements (e.g., N_{RB, raw} for a neighboring cell may equal 6 or 8).

In some embodiments in which an interfering frequency band of the first subscription de-senses a frequency band of the second subscription and does not experience de-sense (i.e., the interfering frequency band is in an “aggressor-only” scenario), the device processor may apply a negative bias to the actual RSRP measurement of the interfering frequency band based on a filtered uplink transmitted power (“P_{FiltTx}”) and a Tx de-sense threshold (“TX_{TH}”) of the first subscription, with both factors in dB. In such embodiments, the device processor may generate a negative bias for the interfering frequency band when TX_{TH} does not exceed P_{FiltTx} such that the negative bias equals the difference between TH_{TH} and P_{FiltTx} in dB. As a non-limiting example, the modified RSRP measurement (“RSRPₘ”) in dB for the interfering frequency band may be calculated based on following equation:

RSRPₘ=RSRP_{RAW}−α_{PV}×min[MPLₚ,max[0,P_{FiltTx}^{S}+Δ_{PL}−TX_{TH}]]

where P_{FiltTx}^{S} is a filtered, uplink transmitted power in dB of the first subscription's serving cell and Δ_{PL} is an approximated uplink path loss (“PL”) compensating factor in dB that is based on the interfering frequency band's downlink path losses of a serving or neighboring cell. Further, as described, MBLₚ may be a configurable RSRP bias limit in dB, RSRP_{RAW} is the actual RSRP measurement in dB, α_{PV} is a configurable scaling factor of the negative bias, and MBLₚ is a configurable RSRP bias limit in dB. In some embodiments, the term P_{FiltTx}^{S} may represent the 90^{th} percentile of the serving cell's transmitted power over a certain number of seconds (e.g., two seconds).

In some embodiments, the device processor may adjust the term Δ_{PL} to compensate for the unknown uplink transmitted power of neighboring cells. For example, Δ_{PL} for a serving cell (ΔP_{PL}^{s}) may be equal to zero because P_{FiltTx}^{S} and the TX_{TH} of the serving cell are both related to the serving cell. In another example, Δ_{PL} for a neighboring cell (Δ_{PL}ⁿ) may be equal to the difference between the neighboring cell's path loss (PLⁿ) and the path loss of the serving cell (“PL^{s}”). This relationship may be represented in the following equations:

Δ_{PL}ⁿ=PLⁿ−PL^{s}

Δ_{PL}ⁿ=(RSPⁿ−RSRP_{raw}ⁿ)−(RSP^{s}−RSRP_{raw}^{s})

Δ_{PL}ⁿ=(RSRP_{raw}^{s}−RSRP_{raw}ⁿ)+(RSP_{raw}ⁿ−RSP_{raw}^{s})

where RSPⁿ is a reference signal power in dB of a neighboring cell, RSPS is a reference signal power of the first subscription's serving cell, RSRP_{raw}ⁿ is the actual/raw RSRP in dB of the neighboring cell, and RSRP_{raw}^{s} is the actual/raw RSRP in dB of the first subscription's serving cell. Both RSPⁿ and RSP^{s} are broadcasted reference signal powers, which are carried in the system information block from the eNB or base stations. RSRP_RAWⁿ and RSRP_rawⁿ are measured RSRPs.

In some embodiments in which an interfering frequency band of the first subscription de-senses a frequency band of the second subscription and also experience de-sense from another frequency band (i.e., the interfering frequency band is in an “victim-and-aggressor” scenario), the device processor may calculate a negative bias by performing operations similar to those described when the interfering frequency band is determined to be in a “victim only” scenario. In some embodiments, the device processor may opt to apply a victim-based negative bias instead of both a victim-based negative bias and an aggressor-based negative bias to prevent calculating a negative bias that is too large.

In some embodiments, rather than (or in addition to) modifying the RSRP measurement for an interfering frequency band of the first subscription, the device processor may perform various operations to generate a modified RSRQ measurement for the interfering frequency to increase the likelihood that the first subscription moves to a non-interfering frequency band. As described with reference to generating modified RSRP measurements, the device processor may utilize different techniques/calculations based on whether the device processor determines that the interfering frequency band is in a victim-only scenario, in an aggressor-only scenario, or in a victim-and-aggressor scenario.

In some embodiments in which the interfering frequency of the first subscription is in a victim-only scenario, the device processor may generate a modified RSRQ measurement (“RSRQₘ”), which is in a linear unit, for the interfering frequency using a calculation similar to the following non-limiting example equation:

$${RSRQ}_{m} = {N}_{RB , raw} \times ( \frac{{RSRP}_{raw}}{{RSSI}_{raw} + {P}_{interference}} )$$

where terms N_{RB, raw}, RSRP_{raw}, and RSSI_{RAW} are as described above and the term P_{interference} is the RF coexistence interference associated with the interfering frequency band. In some embodiments, P_{interference} may not be known explicitly, and in such embodiments, the device processor may approximate P_{interference} based on the following equation:

$${RSSI}_{raw} + {P}_{interference} \approx {RSSI}_{raw} + max [ 0 , {RX}_{TH} + 10 {log}_{10} \frac{{N}_{RB , raw}}{{N}_{RB , TH}} - {RSSI}_{raw} ] .$$

In some embodiments, the device processor may calculate RSRQₘ in dB for an interfering frequency band in a victim-only scenario by applying one or more scaling factors and bias limitations that limit the impact of the negative bias, such as represented in the following equation:

$${RSRQ}_{m} + {RSRQ}_{RAW} - {α}_{QV} \times min [ {MPL}_{Q} , max [ 0 , {RX}_{TH} + 10 {log}_{10} \frac{{N}_{RB , raw}}{{N}_{RB , TH}} - {RSSI}_{raw} ] ] ,$$

where α_{QV} is be a scaling factor of the negative bias (e.g., equal to 0.5) and MPL_{Q} may be a configurable RSRQ bias limit (e.g., equal to 7.5 dB) to prevent drastic decreases in serving cell measurements that may cause blind handovers or dropped calls. In some embodiments in which the first subscription's interfering frequency is in a victim-and-aggressor scenario, the device processor may generate a modified RSRQ in dB by performing operations and calculations similar to those operations and calculations performed when the interfering frequency band is only a victim.

In some embodiments in which the interfering frequency of the first subscription is in an aggressor-only scenario, the device processor may calculate the modified RSRQ measurement for the interfering frequency band based on, among other things, the interfering frequency band's transmitter power (“P_{FiltTx}”) in dB and a Tx de-sense threshold (“TX_{TH}”) in dB, as described with reference to generating a modified RSRP measurement in an aggressor-only scenario. In some embodiments, the device processor may calculate a negative bias to apply to the actual RSRQ measurement of the interfering frequency band based on a difference between P_{FiltTx} and TX_{TH}, which may be used to generate an overall modified RSRQ measurement. In some embodiments, the device processor may utilize various scaling factors and limitations when generating the modified RSRQ value, such as represented in the following non-limiting example equation:

RSRPₘ=RSRQ_{RAW}−α_{QV}×min[MPL_{Q},max[0,P_{FiltTx}^{S}+Δ_{PL}−TX_{TH}]]

where α_{QA} is a scaling factor of the negative bias (e.g., equal to 0.5) and MPL_{Q} is a lower bound to ensure that the negative factor is not severe enough to negatively impact the mobile communication device, as described.

FIGS. 17A-17B illustrate example data tables 1700, 1725 that a multi-subscription-multi-active mobile communication device (e.g., the multi-subscription-multi-active mobile communication device 1500 described with reference to FIG. 15) may reference in order to anticipate/avoid coexistence interference and to generate modified power measurements for a first subscription's interfering and/or non-interfering frequency bands.

With reference to FIGS. 1-17B, the example data table 1700 may include a list of the frequency bands available to each of each of two subscriptions operating on the multi-subscription-multi-active mobile communication device. For example, the data table 1700 may indicate that a first subscription (labeled in FIG. 17A as “Subscription₂”) may utilize at least one of frequency bands “A” and “B” to receive service from the first subscription's network. A second subscription (labeled in FIG. 17A as “Subscription”) may be capable of using frequency bands “X” and “Y” to receive service from the second subscription's network.

In some embodiments, a device processor (e.g., the general processor 1506, the baseband modem processor 1516, the coexistence management unit 1530, a separate controller, and/or the like) may identify the frequency bands that are available for each subscription based on information regarding available frequency bands received directly from each of those subscriptions and/or indirectly from those subscriptions' respective networks.

To detect and/or anticipate when coexistence interference between the first subscription and the second subscription may occur, the device processor may reference a data table, such as the example frequency-band-interference data table 1725. In some embodiments, the frequency-band-interference data table 1725 may include information regarding frequency bands that interfere with certain other frequency bands. For example, if frequency band “X” is currently available to the second subscription, the device processor may use the frequency-band-interference data table 1725 to determine that frequency band “A” will interfere with the frequency band “X” of the second subscription but that the frequency band “B” will not interfere with the frequency band “X.” Thus, in the if the first subscription is currently utilizing the frequency band “A” or needs to select a frequency band with which to establish communications (e.g., in the event of a cell handover or recovery from an out-of-service condition) while the second subscription is utilizing the frequency band “X” (i.e., when there is coexistence interference between frequency bands “A” and “X”), the device processor may use the frequency-band-interference data table 1725 to determine that the frequency band A of the first subscription is an interfering frequency band and that frequency band “B” is a non-interfering carrier frequency. Based on such a determination, the device processor may apply a negative bias to the signal power measurements of the interfering frequency band A and/or apply a positive bias to the signal power measurements of the non-interfering frequency band B to increase the likelihood that the first subscription will move to or select the non-interfering frequency band B from the interfering frequency band A (see, e.g., FIGS. 16A-16B).

In some embodiments, the device processor may calculate the negative and/or positive biases based at least in part on a measure of the amount of interference associated with the first subscription's interfering frequency band. For example, as illustrated in the frequency-band-interference data table 1725, the device processor may perform a table-lookup operation to determine that the first subscription's interfering frequency band “A” experiences an amount of interference “S” when the second subscription uses frequency band “X” (i.e., the first subscription is a victim of de-sense). In a similar example, the device processor may perform a table-lookup operation to determine that the first subscription's interfering frequency band “A” causes an amount of interference “V” to the second subscription's frequency band “X” (i.e., the second subscription is a victim of the first subscription's de-sense). In such examples, the device processor may factor in the amount of interference associated with the first subscription's interfering frequency band when generating the interfering frequency band's modified signal power measurements as described.

In some embodiments, two carrier frequencies may interfere with each other in the event that they are the same, overlap, and/or otherwise have characteristics (e.g., be harmonics or sub-harmonics thereof) known to cause interference with each other. Such interference can be determined in advance by a manufacturer of the multi-subscription-multi-active mobile communication device, a manufacturer of the modems, network operators, and independent parties (e.g., protocol organization, independent testing labs, etc.). Thus, the frequency-band-interference data table 1725 may be predefined and loaded in memory of the mobile communication device, within one or more of the SIMs, or within a modem within the device. In some embodiments, the multi-subscription-multi-active mobile communication device may be configured to generate a frequency-band-interference data table (e.g., the frequency-band-interference data table 1725) by recognizing when de-sense is occurring and recording the frequency bands in use at the time by each of the subscriptions.

In various embodiments, a data table (e.g., the data tables 1700, 1725) may be organized according to a variety of data structures or formats, such as an associative list, a database, a linked list, etc. For example, the frequency-band-interference data table 1725 is a simple data table in which a frequency band may be used as a look-up data field to determine the frequency bands that will interfere with that frequency band.

While the mobile communication device may reference one or more data tables, such as those described above, to identify interfering or potentially interfering frequency bands for the first subscription, in some embodiments, the device processor may monitor the first subscription's frequency bands and calculate/detect de-sense associated with the first subscriptions frequency bands as it occurs. In other words, the device processor may identify and/or calculate the interference experience by or caused by one or more of the first subscription's frequency bands in real time and may generate modified power measurements based on those real-time calculations.

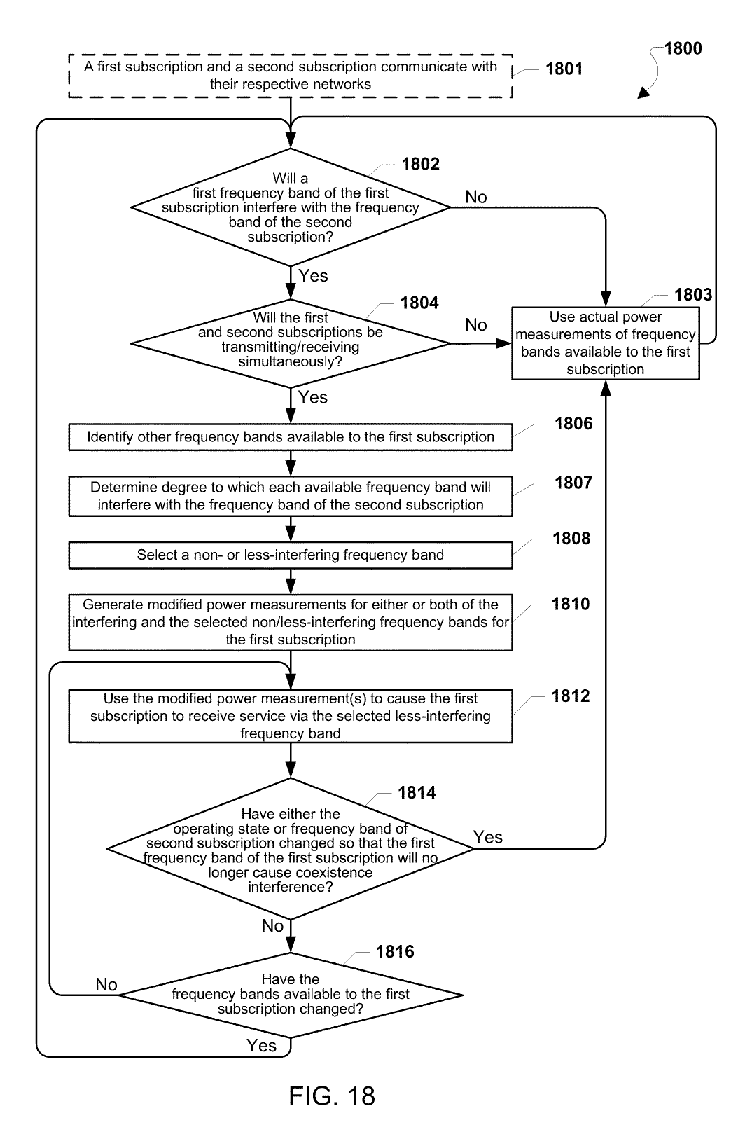

FIG. 18 illustrates a method 1800 for utilizing modified power measurements to cause a first subscription of a mobile communication device to move from an interfering frequency band to a non-interfering frequency band, according to some embodiments. The method 1800 may be implemented with a processor (e.g., the general processor 1506 of FIG. 15, the baseband modem processor 1516, the coexistence management unit 1530, a separate controller, and/or the like) of a multi-subscription-multi-active communication device (e.g., the multi-subscription-multi-active mobile communication device 1500 described with reference to FIGS. 15A and 16A).

With reference to FIGS. 1-18, the device processor may begin performing operations of the method 1800 when a first subscription and the second subscription of the multi-subscription-multi-active mobile communication device are communicating with their respective networks in block 1801.

In determination block 1802, the device processor may monitor the frequencies used by the radios supporting the first and second subscriptions to determine whether the frequency band of the first subscription will interfere with the frequency band of the second subscription if the two subscriptions are transmitting and/or receiving at the same time. In some embodiments, the device processor may perform a table-lookup operation in a frequency-band-interference data table (e.g., the data tables 1700, 1725 of FIG. 17) to anticipate/determine whether the frequency band of the first subscription will interfere with the frequency band of the second subscription. In response to determining that the frequency band of the first subscription will not interfere with the frequency band of the second subscription (i.e., determination block 1802=“No”), the device processor may use (i.e., transmit to the network) actual power measurements of the frequency bands available to the first subscription according to conventional methods in block 1803.

In response to determining that the frequency band of the first subscription will interfere with the frequency band of the second subscription (i.e., determination block 1802=“Yes”), the device processor may determine whether coexistence interference is or will occur by determining whether the first and second subscriptions will be transmitting and/or receiving simultaneously in determination block 1804. This determination may consider whether either subscription is on an active call (e.g., a data or voice call) that would involve transmitting or receiving at the same time that the other subscription would be transmitting or receiving. This determination may also consider whether periodic communication with their respective networks by the two subscriptions are likely to coincide (e.g., a paging collision) frequently enough to degrade the performance of either subscription. In response to determining that the first and second subscriptions will not be transmitting and/or receiving simultaneously, or at least not often enough to degrade performance (i.e., determination block 1804=“No”), the device processor may use (e.g., transmit to the network) actual power measurements of the frequency bands available to the first subscription according to conventional methods in block 1803.

In response to determining that the first and second subscriptions will be transmitting and/or receiving simultaneously, or at least often enough to degrade performance of the second subscription (i.e., determination block 1804=“Yes”), the device processor may use the radio resource of the first subscription to identify all or additional frequency bands available to support the first subscription in block 1806. As described, additional frequency bands may be available from neighboring cells. The process of identifying all or additional available frequency bands may also include obtaining power measurements for the bands. In block 1807, the device processor may determine the degree to which each available frequency band will (or would) interfere with the frequency band of the second subscription. Again, this may be accomplished through a table look up process using the frequency-band-interference data table (e.g., the data tables 1700, 1725 of FIG. 17). Using information from such an interference data table and received power measurements, the device processor may determine the extent (if any) to which each available frequency band would interfere with the frequency band of the second subscription. As part of the operations in block 1807, the device processor may determine the extent to which each interfering frequency band will interfere with the frequency band of the second subscription. For example, the device processor may reference a frequency-band-interference data table that includes information regarding the degree of interference associated with the first subscription's interfering frequency bands (see, e.g., FIG. 17B).

Based on the determined degree to which each available frequency band will interfere with the frequency band of the second subscription, the device processor may select a non-interfering or less-interfering frequency band (referred to as a second frequency band in the claims) from among the frequency bands available to the first subscription in block 1808. For example, if there are multiple non-interfering frequency bands available to the first subscription (i.e., frequency bands that will not interfere with the frequency band of the second subscription), the processor may select the non-interfering frequency band with the highest power measurement as the second frequency band for which the power measurements will be modified. As another example, if there are no non-interfering frequency bands but one of the frequency bands will cause less interference with the frequency band of the second subscription, the processor may select that less-interfering frequency band as the second frequency band for which the power measurements will be modified.

In block 1810, the device processor may generate modified power measurements for the current interfering frequency band, one or more other frequency bands available to the first subscription, or both the current frequency band and other frequency bands available to the first subscription in order to cause the first subscription to begin using a non-interfering or less-interfering frequency band, such as the selected second frequency band. The operations in block 1810 may include decreasing a power measurement of the current interfering frequency band (and other frequency bands that would interfering with the frequency band of the second subscription), increasing a power measurement of one or more other frequencies available to the first subscription that would not interfere (“non-interfering frequency bands”) with the frequency band of the second subscription, or both decreasing power measurements of interfering frequency bands and increasing power measurements of non-interfering frequency bands.

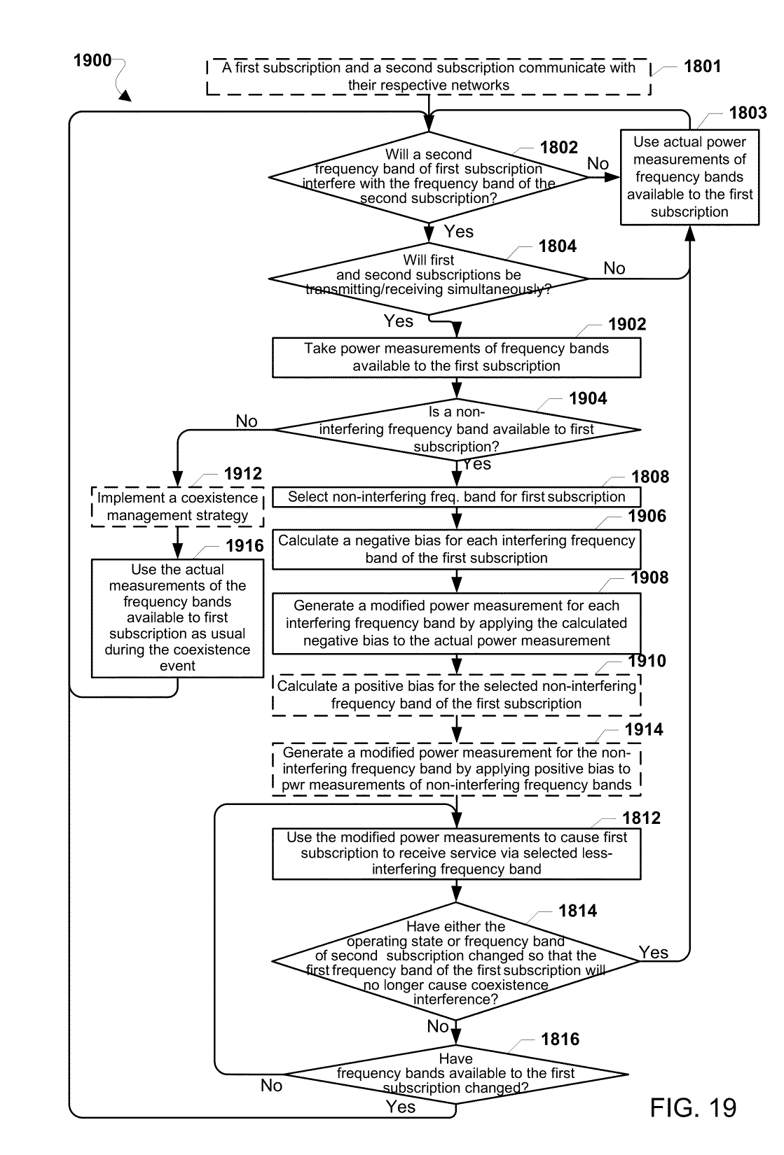

As described (see, e.g., FIGS. 16A-16B and 19), the device processor may decrease the power measurement of the interfering frequency band in block 1810 by calculating a negative biases to apply to the power measurements of interfering frequency bands available to the first subscription and apply those negative biases to actual power measurements of the interfering to produce modified power measurements. The modified power measurements thus may falsely indicate that the interfering frequency bands are less preferred for use (e.g., they have lower power measurements) than the interfering frequency bands' actual power measurements. In some embodiments, the device processor may apply negative modifications to the actual power measurements of the interfering frequency bands based on a maximum power threshold and/or based on the actual power measurements of the first subscription's one or more non-interfering frequency bands. For example, the device processor may calculate negative biases that, when applied to the actual power measurements of interfering frequency bands, would ensure that the resulting modified power measurements do not exceed the maximum power threshold and/or exceed the actual power measurements of one or more non-interfering frequency bands.

In some embodiments of the operations performed in block 1810, the device processor may also or alternatively generate modified power measurements for non-interfering or less-interfering frequency bands by calculating positive biases for those frequency bands and by applying the positive biases to the actual power measurements of the one or more non-interfering frequency bands. In such embodiments, applying the positive biases to the actual power measurements of the one or more non- and less-interfering frequency bands may cause those modified power measurements to appear better than the non-interfering frequency bands' actual power measurements. For example, the device processor may apply positive biases to the one or more non-interfering frequency bands' actual power measurements to ensure that those modified power measurements exceed the actual power measurements of the one or more interfering frequency bands.

In block 1812, the device processor may use the modified power measurements to cause the first subscription to receive service via a frequency band that is not associated with the coexistence interference, such as by prompting the network to cause the first subscription to perform a handover to a non-interfering frequency band, such as on a neighboring cell. As a result, by moving the first subscription to a non-interfering frequency band, the first and second subscription may avoid the coexistence interference, thereby improving one or both of the subscriptions' overall performances.

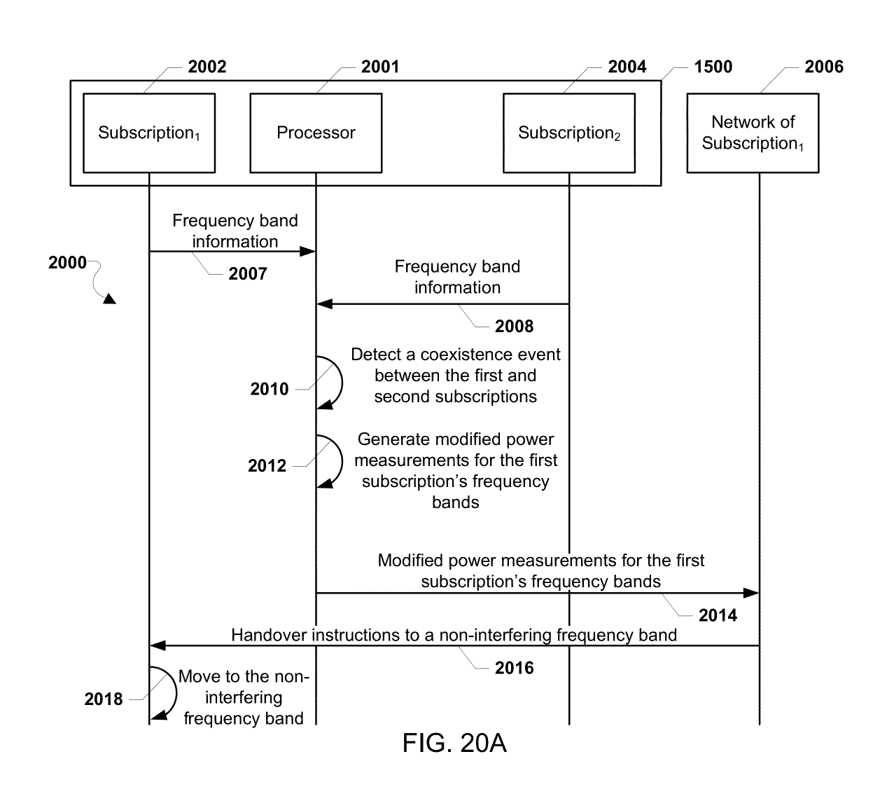

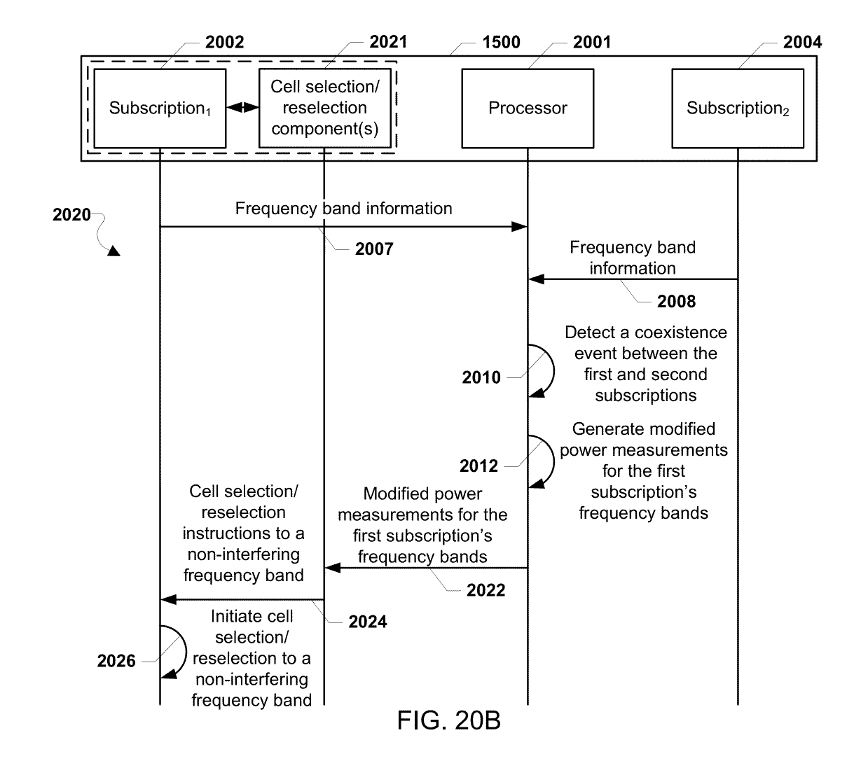

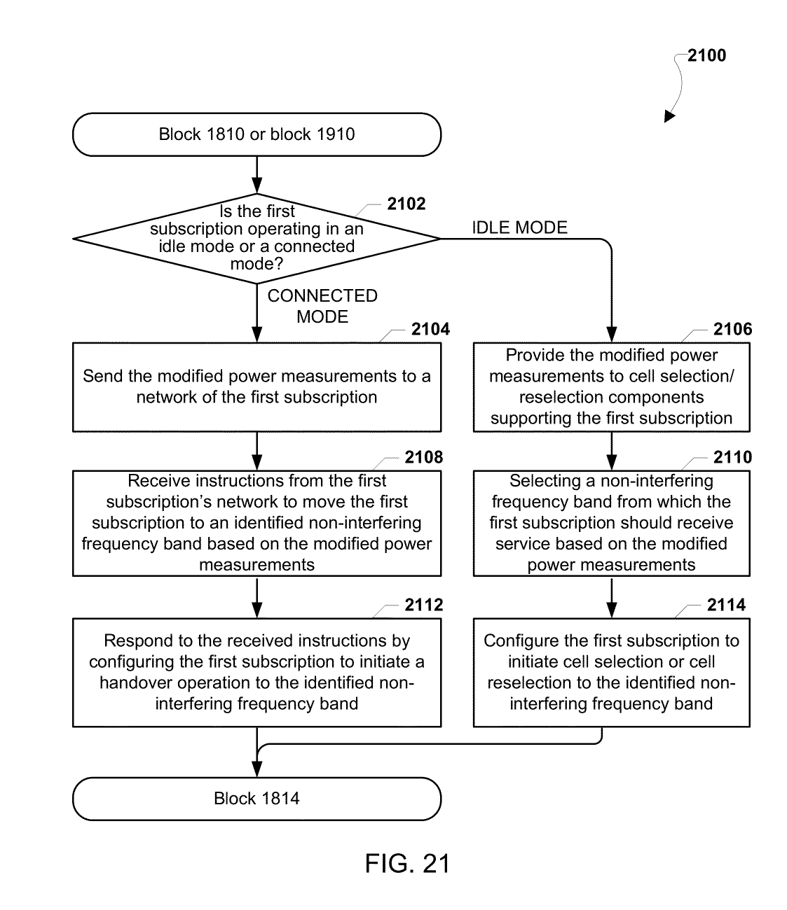

In some embodiments of the operations performed in block 1812 when the first subscription is operating in an idle mode (see, e.g., FIGS. 20B-21), the device processor may utilize the modified power measurements by providing those measurements to one or more components on the multi-subscription-multi-active mobile communication device responsible for supporting the first subscription's cell selection and/or cell reselection operations. In such embodiments and circumstances, the cell selection/reselection components may receive the modified power measurements without being aware that the power measurements are modified or adjusted, and as a result, the cell selection/reselection components may use those measurements to configure the first subscription to move from the current frequency band (i.e., an interfering frequency band) to another frequency band (i.e., a non-interfering frequency band) that appears to offer better service.

In some embodiments of the operations performed in block 1812, when the first subscription is operating in a connected mode (see, e.g., FIGS. 20A and 21), the device processor may send the modified power measurements to the first subscription's network. In response, the first subscription's network may perform various calculations and determinations based on the modified subscription (e.g., using known methods) and may send instructions for the first subscription to move from an interfering frequency band to a non-interfering frequency based on the modified power measurements.

In some embodiments, the device processor may only use the modified power measurements for band-avoidance purposes and may use actual power measurements for other purposes, such as downlink-path-loss calculations.

In determination block 1814, the device processor may monitor the conditions that lead to coexistence interference between the first subscription and the second subscription to determine whether the conditions change such that original frequency band of the first subscription will no longer cause coexistence interference with the frequency band of the second subscription. For example the device processor may determine whether the second subscription has changed operating state, such as ending a data or voice call, such that transmissions and receptions of the two subscriptions are unlikely to collide enough to impact performance of either subscription. As another example, the device processor may determine whether the frequency band of the second subscription has changed, such as due to a cell handover. In response to determining that an operating state of the second subscription has changed such that the original frequency band of the first subscription will no longer interfere with the current frequency band of the second subscription (i.e., determination block 1814=“Yes”), the device processor may return to using (e.g., transmitting to the network) actual power measurements of the frequency bands available to the first subscription according to convention methods in block 1803.

In response to determining that coexistence interference may still occur between the original frequency band of the first subscription and the current frequency band of the second subscription (i.e., determination block 1814=“No”), the device processor may determine whether the frequency bands available to the first subscription have changed in determination block 1816. In some embodiments, while the coexistence interference between the first subscription and the second subscription is ongoing, the device processor may periodically determine whether new or updated power measurements, available frequency bands, etc., are available for the first subscription that may justify updating the modified power measurements generated in block 1810. For example, the mobile communication device may enter a new area that may provide the first subscription with access to additional frequency bands and, thus, new or different modified power measurements may need to be generated to continue to avoid the possibility of coexistence interference between the subscriptions. In another example, the mobile communication device may enter an area in which the actual power measurements of the frequency bands available to the first subscription are different, thereby requiring adjustments to the modified power measurements for the first subscription's frequency bands to ensure that the first subscription continues receiving service via a non-interfering frequency band. In response to determining that the frequency bands available to the first subscription have not changed (i.e., determination block 1816=“No”), the device processor may continue to use the modified power measurements in block 1812.

In response to determining that the frequency bands available to the first subscription has changed (i.e., determination block 1816=“Yes”), the device processor may repeat the operations of determining whether a frequency band of the first subscription will interfere with the frequency band of the second subscription in determination blocks 1802 and 1804 as described.

FIG. 19 illustrates a method 1900 for applying biases to actual power measurements of a first subscription's available frequency bands to generate modified power measurements according to some embodiments. The method 1900 may be implemented with a processor (e.g., the general processor 1506 of FIG. 15, the baseband modem processor 1516, the coexistence management unit 1530, a separate controller, and/or the like) of a multi-subscription-multi-active communication device (e.g., the mobile communication device 1500 described with reference to FIGS. 15A and 16A).

With reference to FIGS. 1-19, the device processor may perform the operations of blocks 1801 through determination block 1804 as described for like numbered blocks with reference to FIG. 18. In response to determining that a first frequency band of the first subscription will interfere with the frequency band of the second subscription (i.e., determination block 1802=“Yes”) and that the first and second subscriptions will be transmitting and/or receiving simultaneously (i.e., determination block 1804=“Yes”), the device processor may take actual measurements of frequency bands available to the first subscription in block 1902, such as by performing known operations. For example, the device processor may take RSRP and/or RSRQ measurements for each of the frequency bands available to the first subscription.

In determination block 1904, the device processor may determine whether a non-interfering frequency band is available to the first subscription, such as by identifying the bands that are available to the first subscription and to the second subscription and referencing a data table of interfering frequency bands to determine whether the first subscription is able to move to a frequency band that would avoid or mitigate de-sense between that frequency band and the second subscription's frequency bands. In some embodiments, the device processor may determine whether there is a frequency band available to the first subscription that would experience or cause less or “milder” de-sense during the coexistence interference, with such frequency band being deemed “non-interfering” in comparison to one or more of the first subscription's other frequency bands that may cause or experience more coexistence interference during the coexistence interference.

In response to determining that a non-interfering frequency band is not available to the first subscription (i.e., determination block 1904=“No”), the device processor may optionally implement a coexistence management strategy in optional block 1912, such as by implementing Tx or Rx blanking on the first subscription's transmissions and receptions operations, respectively. In such situations, the device processor may utilize the actual measurements of frequency bands available to the first subscription as usual during the coexistence interference in block 1916. The device processor may continue performing operations of monitoring for another instance of coexistence interference between the first subscription and the second subscription in block 1802 as described.

In response to determining that a non-interfering (or lesser-interfering) frequency band is available to the first subscription (i.e., determination block 1904=“Yes”), the device processor may select a non-interfering or less-interfering frequency band from among the frequency bands available to the first subscription in block 1808 as described. The device processor may calculate a negative bias for each of the first subscription's interfering frequency bands in block 1906. As described (see FIGS. 16B-17B), the device processor may adjust the actual power measurements of each of the first subscription's interfering frequency bands as determined in block 1902 to ensure that a non-interfering frequency band will receive preference over the interfering frequency bands, thereby increasing the likelihood that the first subscription will be moved from an interfering frequency band to a non-interfering frequency band. In some embodiments of the operations performed in block 1906, the device processor may reduce the actual power measurements for each of the interfering frequency bands below a certain maximum power measurement threshold, which may correspond with the actual power measurement of one or more non-interfering frequency bands. For example, the negative bias for an interfering frequency band may be calculated based at least in part on the difference between the interfering frequency band's actual power measurement and the maximum power threshold.

In block 1908, the device processor may apply a negative bias to actual power measurements of frequency bands in the list of interfering frequency bands to generate modified power measurements, such as by applying one or more adjustments to the actual power measurements (e.g., as described with reference to FIG. 16B) to generate biased power measurements of the interfering frequency bands.

In some optional embodiments, the device processor may additionally (or alternatively) calculate a positive bias for the selected non- or less-interfering frequency band or all of the non-interfering frequency bands available to the first subscription in optional block 1910. In other words, the device processor may determine positive biases that may be applied to one or more non- or less-interfering frequency bands of the first subscription to increase the likelihood that the first subscription will move from an interfering frequency band to one of the non- or less-interfering frequency bands. In some embodiments, the device processor may calculate the positive biases for the non-interfering frequency bands based on the actual or adjusted power measurements of the interfering frequency bands. For example, in such embodiments, the device processor may calculate the positive bias for a non-interfering frequency band such that, when the positive bias is applied to the non-interfering frequency band actual power measurement, the non-interfering band will appear to have a better signal strength than the first subscription's interfering frequency bands.

In optional block 1914, the device processor may apply a positive bias to actual power measurements of the non-interfering frequency bands to generate modified power measurements, such as by performing operations similar to those described with reference to block 1908 (see, e.g., FIG. 16B.).

The device processor may report or utilize the modified power measurements in block 1812 to cause the first subscription to move to a non-interfering frequency band from an interfering frequency band as described. The device processor may determine whether either the operating state or frequency band of the second subscription has changed such that the first frequency band of the first subscription will no longer cause coexistence interference in determination block 1814. In response to determining that either the operating state or frequency band of the second subscription has changed such that coexistence interference is no longer likely (e.g., determination block 1814=“Yes”), the device processor use the actual power measurements of the frequency bands available to the first subscription in block 1803 as described.

In parallel or in response to determining that the operating state and/or frequency band of the second subscription has not changed sufficient to remove the risk of coexistence interference with the first frequency of the first subscription (i.e., determination block 1814=“No”), the device processor may determine whether the frequency bands available to the first subscription have changed in determination block 1816 as described. As long as the operating state and/or frequency band of the second subscription has not changed sufficient to remove the risk of coexistence interference with the first frequency of the first subscription (i.e., determination block 1814=“No”) and the frequency bands available to the first subscription remain unchanged (i.e., determination block 1816=“No”), the device processor may continue to use the modified power measurements to cause the first subscription to receive service via the selected less-interfering frequency band. In response, to determining that the frequency bands available to the first subscription have changed (i.e., determination block 1816=“Yes”) the device processor may repeat the method 1900 by determining whether a new first frequency available to the first subscription will interfere with the frequency band of the second subscription in determination block 1802 as described.

FIG. 20A is a signaling and call flow diagram 2000 illustrating communications exchanged between components of a multi-subscription-multi-active communication device (e.g., the mobile communication device 1500 of FIGS. 15 and 16A) and a network of a first subscription of the multi-subscription-multi-active communication device for increasing the likelihood that the network instructs the first subscription to move from an interfering frequency band to a non-interfering frequency band while the first subscription is operating in a connected mode. With reference to FIGS. 1-20A, the mobile communication device 1500 may include a first subscription 2002 for communicating with a network 2006, a device processor 2001 (e.g., the coexistence management unit 1530, the general processor 1502, the baseband modem processor 1516, etc.), and a second subscription 2004 for communicating with a second network (not shown).

In some embodiments, the first subscription 2002 may provide information regarding the frequency band used by the subscription to the device processor via a signal 2007. In such embodiments, the frequency band information may include various details about the first subscription's frequency bands, such as the frequency bands in the area that are currently available to the first subscription, the frequency band(s) currently in use by the first subscription, etc. In some embodiments, the frequency band information may include information related to the frequency band(s) the first subscription may use while communicating with the network 2006 in a connected mode.

The device processor 2001 may also receive frequency band information from the second subscription 2004 via another signal 2008. In some embodiments, the frequency band information received from the second subscription 2004 may be similar to the frequency band information received from the first subscription 2002. In such embodiments, the frequency-band information of the second subscription 2004 may enable the device processor 2001 to identify the frequency bands that are currently available and/or in use by the second subscription 2004.

In operation 2010, the device processor 2001 may detect or predict a coexistence interference between the first subscription 2002 and the second subscription 2004, such as by performing a table-lookup operation in a frequency-band-interference table (e.g., the frequency-band-interference data table 1725), which may identify combinations of frequency bands in use or available to the first subscription 2002 and the second subscription 2004 that may result in coexistence interference. For example, the device processor 2001 may determine that there is a high likelihood that the frequency band currently in use by the first subscription 2002 will de-sense a frequency band that the second subscription 2004 is using or is likely to use in the near future, or vice versa.

In response to detecting the coexistence interference between the first subscription 2002 and the second subscription 2004, the device processor may generate modified power measurements for the first subscription's frequency bands (operation 2012), such as by performing operations of the method 1900 (e.g., as described with reference to FIG. 19). For example, the device processor 2001 may generate modified power measurements for non-interfering frequency bands of the first subscription 2002 that are greater than the actual power measurements associated with those frequency bands. Similarly, the device processor 2001 may similarly additionally (or alternatively) generate modified power measurements for interfering frequency bands of the first subscription 2002 that are worse/less than the actual power measurements for those interfering frequency bands.

In some embodiments in which the first subscription 2002 is operating in a connected mode, the network 2006 may be responsible for allocating available resources (e.g., frequency bands) to various mobile communication devices and thus may coordinate with the first subscription 2002 to allocate a frequency band for the first subscription 2002's use in communicating with the network 2006. In such embodiments, the network 2006 may be responsible for instructing the first subscription 2002 to perform handover operations to other frequency bands based on signal power measurements received from the mobile communication device 1500. For example, in response to receiving a signal strength report from the first subscription indicating that the first subscription's current frequency band has a lower signal strength than another available frequency band, the network 2006 may instruct the first subscription to perform a handover from the first subscription's current frequency band to the frequency band with an apparently higher signal strength/power measurement.

Thus, in various embodiments, while the first subscription is operating in a connected mode, the device processor 2001 may send the modified power measurement for the first subscription's frequency bands to the network 2006 via a signal 2014 in order to increase the likelihood that the network 2006 will instruct the first subscription 2002 to move to a frequency band that will not interfere with the frequency band(s) of the second subscription 2004 (i.e., in order to avoid the coexistence interference between the first subscription 2002 and the second subscription 2004).

In response to receiving the signal 2014 that includes the modified power measurements, the network 2006 may send handover instructions to the first subscription 2002 (via a signal 2016) that cause the first subscription 2002 to move from an interfering frequency band to a non-interfering frequency band in operation 2018.

FIG. 20B is a signaling and call flow diagram 2020 illustrating communications exchanged between components of a multi-subscription-multi-active communication device (e.g., the mobile communication device 1500 of FIGS. 15, 16A, and 20A) for increasing the likelihood that a first subscription performs cell selection or cell reselection to move from an interfering frequency band to a non-interfering frequency band while the first subscription is operating in an idle mode. With reference to FIGS. 1-20B, the mobile communication device 1500 may include the first subscription 2002, the device processor 2001, and the second subscription 2004 as described (see FIG. 20A).

In some embodiments, the device processor 2001 may include one or more cell selection/reselection components 2021 configured to identify frequency bands available to the first subscription 2002 and to instruct the first subscription 2002 to perform cell selection/reselection to a better frequency band based on the relative power measurements of the available frequency bands using known methods while the first subscription 2002 is performing in an idle mode. The cell selection/reselection components 2021 may include one or more of a RAT associated with the first subscription, a communication protocol layer (or layers) of the first subscription, a baseband processor configured to support the first subscription (e.g., the baseband modem processor 1516), etc. In some embodiments (not shown), the cell selection/reselection components 2021 may be software and/or hardware modules included within the device processor 2001.

In various embodiments, the cell selection/reselection components 2021 receive power measurements (e.g., RSRP and/or RSRQ measurements) associated with frequency bands available to the first subscription 2002 in the current area. The cell selection/reselection components 2021 may determine whether the first subscription 2002 should acquire service from (or switch service to) a particular frequency band based on the power measurements of that frequency band in comparison with the power measurements of other available frequency bands. For example, the cell selection/reselection components 2021 may determine that the first subscription 2002 should perform a handover from a first frequency band to a second frequency band that has a higher power measurement than the power measurement of the first frequency band, and the cell selection/reselection components 2021 may configure or instruct the first subscription 2002 to a handover operation to the higher-power frequency band.

Thus, in some embodiments, in order to avoid coexistence interference between the first subscription 2002 and the second subscription 2004 while the first subscription operates in an idle mode, the device processor 2001 may adjust the actual power measurements of frequency bands available to the first subscription 2002 to prompt the cell selection/reselection components 2021 to instruct/cause the first subscription to select/reselect to a frequency band that will not interfere with (or be interfered by) a frequency band of the second subscription 2004.

In the example illustrated in the signaling and call flow diagram 2020, the first subscription 2002, the device processor 2001, and the second subscription 2004 may perform operations and exchange information as described (see FIG. 20A). Specifically, the first subscription 2002 may send frequency band information to the device processor 2001 via the signal 2007, and the second subscription 2004 may send frequency band information to the device processor via the signal 2008. In response to receiving the frequency band information from the subscriptions 2002, 2004, the device processor 2001 may detect coexistence interference between the first subscription 2002 and the second subscription 2004 in operation 2010 and may generate modified power measurements for the frequency bands of the first subscription 2002 in operation 2012.

However, rather than sending modified power measurements for the first subscription's frequency bands to the first subscription's network (see FIG. 20A), the device processor 2001 may provide these modified power measurements to the cell selection/reselection components 2021 via an internal signal 2022. In some embodiments, the cell selection/reselection components 2021 may be unaware that the power measurements it has received via the signal 2022 are modified, and thus, the modified power measurements may cause the cell selection/reselection components 2021 to determine (not shown) that one or more non-interfering frequency bands of the first subscription will provide better service than the current (i.e., interfering) frequency band of the first subscription 2002. As a result of utilizing the modified power measurements, the cell selection/reselection components 2021 may provide cell selection/reselection instructions to the first subscription via a signal 2024 that cause the first subscription 2002 to perform a cell selection/reselection operation to a non-interfering frequency band in operation 2026, thereby causing the first subscription 2002 to avoid the coexistence interference with the second subscription 2004 detected in operation 2010.

FIG. 21 illustrates a method 2100 for using modified power measurements of a first subscription's frequency bands to cause the first subscription to move from an interfering frequency band to a non-interfering frequency band according to some embodiments. The method 2100 may be implemented with a processor (e.g., the general processor 1506 of FIG. 15, the baseband modem processor 1516, the coexistence management unit 1530, the device processor 2001 of FIGS. 20A-20B, a separate controller, and/or the like) of a multi-subscription-multi-active communication device (e.g., the mobile communication device 1500 described with reference to FIGS. 15A, 16A, and 20A-20B).

The operations of the method 2100 implement some embodiments of the operations in block 1812 of the method 1800 (see FIG. 18). Thus, with reference to FIGS. 1-21, the device processor may begin performing the operations of the method 2100 after generating modified power measurements for one or more of the first subscription's frequency bands based in block 1810 of the method 1800. In some embodiments, the device processor may begin performing the operations of the method 2100 after applying a positive bias to actual power measurements of the first subscription's non-interfering frequency bands in block 1910.

In determination block 2102, the device processor may determine whether the first subscription is operating in an idle mode or in a connected mode, such as by querying the first subscription's current operating status.

In response to determining that the first subscription is operating in an idle mode (i.e., determination block 2102=“IDLE MODE”), the device processor may provide the modified power measurement(s) generated in block 1810 to cell selection/reselection components supporting the first subscription in block 2106. As described (see FIG. 20B), the device processor may provide the modified power measurements to the cell selection/reselection components (e.g., the cell selection/reselection components 2021), and the cell selection/reselection components may perform typical operations to determine whether the first subscription should move to another frequency band based on the modified power measurements.

In block 2110, the cell selection/reselection components may select a non-interfering frequency band available to the first subscription from which the first subscription should begin receiving service based on the modified power measurements provided by the device processor in block 2106. In other words, the device processor may provide the cell selection/reselection components with modified power measurement information in block 2106 that falsely indicates that the first subscription's interfering bands have lower power measurements than at least one non-interfering band, and the cell selection/reselection components may use this false or modified information in block 2110 as input to determine whether the first subscription should move to another frequency band, thereby increasing the likelihood that the cell selection/reselection components determine that the first subscription should move to a non-interfering frequency band. In some embodiments, the cell selection/reselection components may perform the operations in block 2110 by evaluating the modified power measurements using cell selection/reselection calculations or algorithms typically performed on actual power measurements.

In block 2114, the device processor and/or the cell selection/reselection components may configure the first subscription to initiate cell selection or cell reselection to the non-interfering frequency band selected in block 2110. As a result, the first subscription may begin receiving service from a frequency band that does not interfere with a frequency band of the second subscription.

In response to determining that the first subscription is operating in a connected mode (i.e., determination block 2102=“CONNECTED MODE”), the device processor may send the modified power measurements to a network of the first subscription in block 2104. As described (see FIG. 20A), while the first subscription is operating in a connected mode, the first subscriptions network may be responsible for allocating and managing the frequency band that the first subscription utilizes to communicate with the network supporting the subscription. In some embodiments, by sending the modified power measurements to the first subscriptions network, the device processor may cause the first subscriptions network to determine that at least one non-interfering frequency band of the first subscription is capable of providing better service than the first subscription's current, interfering frequency band.

In block 2108, the device processor may receive instructions from the first subscription's network to move the first subscription to an identified non-interfering frequency band based on the modified power measurements sent to the network in block 2104. In other words, because the device processor sent power measurements that falsely indicate that at least one of the first subscription's non-interfering frequency bands is associated with a higher power measurement than the first subscription's interfering frequency bands, the device processor may indirectly influence the outcome of the first subscription's network's determination regarding whether the first subscription should move to another frequency band, thereby increasing the likelihood that the network will determine that the first subscription should move to the at least one non-interfering band in order to receive better service. Further, by providing the modified power measurements, the device processor enables the network to unknowingly instruct the first subscription to move to a non-interfering frequency band without the mobile communication device having to send additional messaging to the network specifically requesting a switch to a non-interfering frequency band.

In block 2112, the device processor may respond to the instructions received in block 2108 by configuring the first subscription to initiate a handover operation to the non-interfering frequency band identified in the instructions received from the first subscriptions network in block 2108.

As a result of the first subscription's moving to a non-interfering frequency band in either block 2112 or block 2114, the first subscription may avoid the interference with the second subscription, which may improve the overall performance of the first subscription and/or the second subscription.

The device processor may continue performing operations of the method 1800 by monitoring the coexistence interference between the first subscription and the second subscription for changes and/or for an end of the coexistence interference in block 1814 as described.

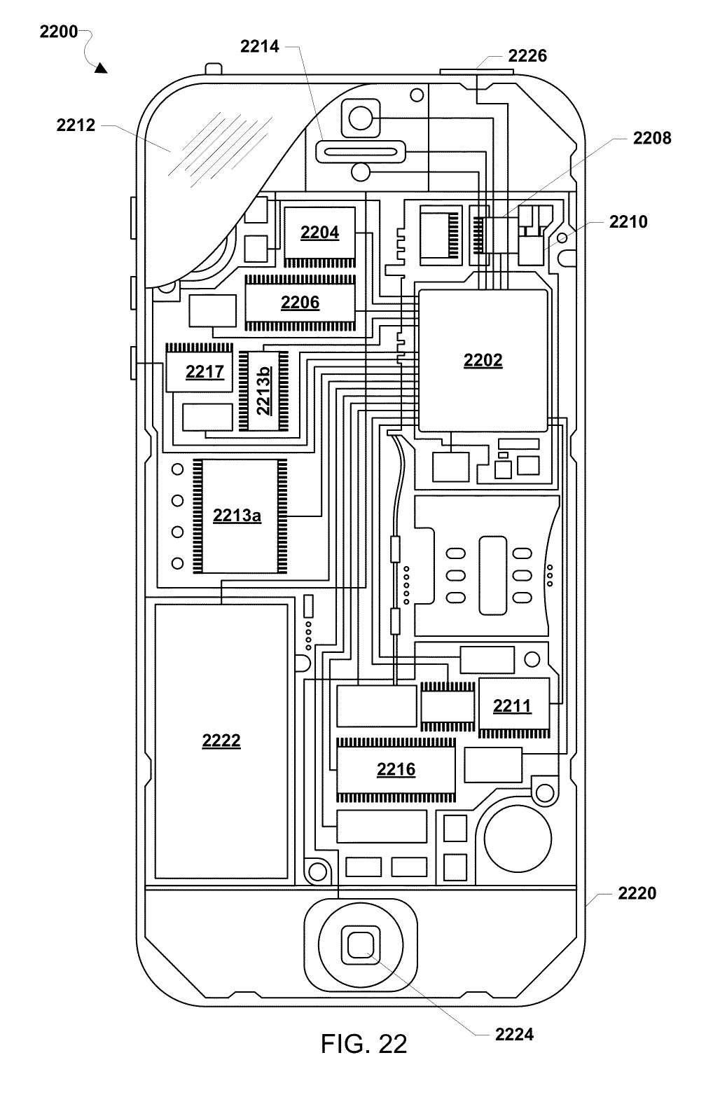

Various embodiments may be implemented in any of a variety of mobile communication devices, an example of which (e.g., mobile communication device 2200) is illustrated in FIG. 22. According to various embodiments, the mobile communication device 2200 may be similar to the mobile communication devices 116, 122, 250, 510, 600, 1010, 1500 as described above with reference to FIGS. 1, 2, 5, 6, 10, 15, 16A, 20A, and 20B. As such, the mobile communication device 2200 may implement the methods 1100, 1200, 1800, 1900, and 2100 in FIGS. 11, 12, 18, 19, and 21.

Thus, with reference to FIGS. 1-22, the multi-subscription-multi-active mobile communication device 2200 may include a processor 2202 coupled to a touchscreen controller 2204 and an internal memory 2206. The processor 2202 may be one or more multi-core integrated circuits designated for general or specific processing tasks. The internal memory 2206 may be volatile or non-volatile memory, and may also be secure and/or encrypted memory, or unsecure and/or unencrypted memory, or any combination thereof. The touchscreen controller 2204 and the processor 2202 may also be coupled to a touchscreen panel 2212, such as a resistive-sensing touchscreen, capacitive-sensing touchscreen, infrared sensing touchscreen, etc. Additionally, the display of the mobile communication device 2200 need not have touch screen capability.

The multi-subscription-multi-active mobile communication device 2200 may have one or more cellular network transceivers 2208, 2216 coupled to the processor 2202 and to two or more antennae 2210, 2211 and configured for sending and receiving cellular communications. The transceivers 2208, 2216 and the antennae 2210, 2211 may be used with the above-mentioned circuitry to implement the various embodiment methods. The multi-subscription-multi-active mobile communication device 2200 may be coupled to two or more SIM cards (e.g., SIMs 2213a, 2213b) that are coupled to the transceivers 2208, 2216 and/or the processor 2202 and configured as described above. The multi-subscription-multi-active mobile communication device 2200 may include a cellular network wireless modem chip 2217 that enables communication via a cellular network and is coupled to the processor 2202.

The multi-subscription-multi-active mobile communication device 2200 may also include speakers 2214 for providing audio outputs. The multi-subscription-multi-active mobile communication device 2200 may also include a housing 2220, constructed of a plastic, metal, or a combination of materials, for containing all or some of the components discussed herein. The multi-subscription-multi-active mobile communication device 2200 may include a power source 2222 coupled to the processor 2202, such as a disposable or rechargeable battery. The rechargeable battery may also be coupled to a peripheral device connection port (not shown) to receive a charging current from a source external to the mobile communication device 2200. The multi-subscription-multi-active mobile communication device 2200 may also include a physical button 2224 for receiving user inputs. The multi-subscription-multi-active mobile communication device 2200 may also include a power button 2226 for turning the mobile communication device 2200 on and off.

Some of the examples above describe aspects implemented in an LTE system. However, the scope of the disclosure is not so limited. Various aspects may be adapted for use with other communication systems, such as those that employ any of a variety of communication protocols including, but not limited to, CDMA systems, TDMA systems, FDMA systems, and OFDMA systems.

It is understood that the specific order or hierarchy of operations in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

What is claimed is:

1. A method implemented on a multi-subscription-multi-active mobile communication device for managing interference between a first subscription and a second subscription in response to determining that a first frequency band used by the first subscription will interfere with a frequency band used by the second subscription, comprising:
generating a modified power measurement for one or both of the first frequency band and a second frequency band available to support the first subscription, wherein the modified power measurement reduces a likelihood that the first frequency band will be used to support the first subscription.

2. The method of claim 1, wherein:
the modified power measurement is a modified power measurement of the first frequency band; and
generating a modified power measurement for the first frequency band comprises decreasing a power measurement for the first frequency band.

3. The method of claim 2, wherein decreasing a power measurement for the first frequency band comprises:
taking a power measurement of the first frequency band;
calculating a negative bias for the first frequency band; and
generating a modified power measurement for the first frequency band by applying the negative bias to the power measurement of the first frequency band.

4. The method of claim 1, wherein:
the modified power measurement is a modified power measurement of the second frequency band; and
generating a modified power measurement of the second frequency band comprises increasing a power measurement for the second frequency band.

5. The method of claim 4, wherein increasing a power measurement for the second frequency band comprises:
taking a power measurement of the second frequency band;
calculating a positive bias for the second frequency band;
generating a modified power measurement for the second frequency band by applying the positive bias to the power measurement of the second frequency band.

6. The method of claim 4, further comprising selecting as the second frequency band a frequency band that will not interfere with the frequency band used by the second subscription.

7. The method of claim 4, further comprising selecting as the second frequency band a frequency band that will cause less interference with the frequency band used by the second subscription than the first frequency band of the first subscription.

8. The method of claim 1, wherein the modified power measurement comprises generating a modified Reference Signal Received Power (RSRP) measurement.

9. The method of claim 1, wherein the modified power measurement comprises a modified Reference Signal Received Quality (RSRQ) measurement.

10. The method of claim 1, further comprising:
determining whether an operating state or frequency band of the second subscription has changed so that the first frequency band of the first subscription will no longer interfere with the frequency band of the second subscription; and
using an actual power measurement for one or both of the first frequency band and the second frequency band of the first subscription in response to determining that the operating state or frequency band of the second subscription has changed.

11. The method of claim 1, further comprising:
determining whether an operating state or frequency band of the second subscription has changed so that the first frequency band of the first subscription will no longer interfere with the frequency band of the second subscription; and
continuing to use the modified power measurement for the first frequency band of the first subscription in response to determining that the operating state or frequency band of the second subscription has not changed.

12. The method of claim 1, further comprising:
identifying frequency bands available to support the first subscription that will interfere with the frequency band of the second subscription (“interfering frequency bands”); and
generating a modified power measurement for each of the interfering frequency bands that reduces the likelihood that an interfering frequency band will be used to support the first subscription.

13. The method of claim 1, further comprising:
identifying frequency bands available to support the first subscription that will not interfere with the frequency band of the second subscription (“non-interfering frequency bands”); and
generating a modified power measurement for each of the non-interfering frequency bands that increases the likelihood that a non-interfering frequency band will be used to support the first subscription.

14. The method of claim 1, further comprising:
sending at least the modified power measurement to a network of the first subscription when the mobile communication device is operating in a connected mode;
receiving, from the network, handover instructions for moving the first subscription to the second frequency band, wherein the handover instructions are based at least in part on the modified power measurement; and
responding to the received handover instructions by configuring the first subscription to initiate a handover operation to the second frequency band.

15. The method of claim 1, further comprising:
providing the modified power measurement to a component on the mobile communication device configured to support cell selection and cell reselection operations for the first subscription when the mobile communication device is operating in an idle mode;
selecting, with the component, the second frequency band of the first subscription based on the modified power measurement; and
configuring the first subscription to initiate one of cell selection and cell reselection to receive service via the second frequency band.

16. A mobile communication device, comprising:
two or more radio frequency (RF) resources; and
a processor coupled to the two or more RF resources and configured to:
generate a modified power measurement for one or both of a first frequency band in use by a first subscription determined to interfere with a frequency band in use by a second subscription and a second frequency band available to support the first subscription, wherein the modified power measurement reduces a likelihood that the first frequency band will be used to support the first subscription.

17. The mobile communication device of claim 16, wherein the processor is further configured to generate a modified power measurement for the first frequency band that reduces the likelihood that the first frequency band will be used to support the first subscription by decreasing a power measurement for the first frequency band.

18. The mobile communication device of claim 17, wherein the processor is further configured to decrease a power measurement for the first frequency band by:
taking a power measurement of the first frequency band;
calculating a negative bias for the first frequency band; and
generating a modified power measurement for the first frequency band by applying the negative bias to the power measurement of the first frequency band.

19. The mobile communication device of claim 16, wherein the processor is further configured to generate a modified power measurement of the second frequency band available to support the first subscription by increasing a power measurement for the second frequency band.

20. The mobile communication device of claim 16, wherein the processor is further configured to increase a power measurement for the second frequency band by:
taking a power measurement of the second frequency band;
calculating a positive bias for the second frequency band;
generating a modified power measurement for the second frequency band by applying the positive bias to the power measurement of the second frequency band.

21. The mobile communication device of claim 19, wherein the processor is further configured to select as the second frequency band a frequency band that will not interfere with the frequency band used by the second subscription.

22. The mobile communication device of claim 19, wherein the processor is further configured to select as the second frequency band a frequency band that will cause less interference with the frequency band used by the second subscription than the first frequency band of the first subscription.

23. The mobile communication device of claim 16, wherein the modified power measurement for one or both of the first and second frequency bands is a modified Reference Signal Received Power (RSRP) measurement.

24. The mobile communication device of claim 16, wherein the modified power measurement for one or both of the first and second frequency bands is a modified Reference Signal Received Quality (RSRQ) measurement.

25. The mobile communication device of claim 16, wherein the processor is further configured to:
determine whether an operating state or frequency band of the second subscription has changed so that the first frequency band of the first subscription will no longer interfere with a frequency band of the second subscription;
use an actual power measurement for the first frequency band of the first subscription in response to determining that the operating state or frequency band of the second subscription has changed so that the first frequency band of the first subscription will no longer interfere with a frequency band of the second subscription; and
continue to use the modified power measurement for the first frequency band of the first subscription to avoid coexistence interference in response to determining that the operating state or frequency band of the second subscription has not changed so that the first frequency band of the first subscription will interfere with a frequency band of the second subscription.

26. The mobile communication device of claim 16, wherein the processor is further configured to:
identify frequency bands available to support the first subscription that will interfere with the frequency band of the second subscription (“interfering frequency bands”) and frequency bands available to support the first subscription that will not interfere with the frequency band of the second subscription (“non-interfering frequency bands”);
generate modified power measurement for each of the interfering frequency bands that reduces the likelihood that an interfering frequency band will be used to support the first subscription; and
generate modified power measurement for each of the non-interfering frequency bands that increases the likelihood that a non-interfering frequency band will be used to support the first subscription.

27. The mobile communication device of claim 16, wherein the processor is further configured to:
send the modified power measurement to a network of the first subscription when the mobile communication device is operating in a connected mode;
receive, from the network, handover instructions for moving the first subscription to the second frequency band, wherein the handover instructions are based on the modified power measurement; and
respond to the received handover instructions by configuring the first subscription to initiate a handover operation to the second frequency band.

28. The mobile communication device of claim 16, further comprising:
provide the modified power measurement to a component on the mobile communication device configured to support cell selection and cell reselection operations for the first subscription when the mobile communication device is operating in an idle mode;
select, with the component, the second frequency band of the first subscription based on the modified power measurement; and
configure the first subscription to initiate one of cell selection and cell reselection to receive service via the second frequency band.

29. A multi-subscription-multi-active mobile communication device, comprising:
means for generating a modified power measurement for one or both a first frequency band in use by a first subscription determined to interfere with a frequency band used by a second subscription and a second frequency band available to support the first subscription, wherein the modified power measurement reduces a likelihood that the first frequency band will be used to support the first subscription.

30. A non-transitory processor-readable storage medium having stored thereon processor-executable software instructions configured to cause a processor of a multi-subscription-multi-active mobile communication device to perform operations comprising:
generating a modified power measurement for one or both of a first frequency band in use by a first subscription determined to interfere with a frequency band used by a second subscription and a second frequency band available to support the first subscription, wherein the modified power measurement reduces a likelihood that the first frequency band will be used to support the first subscription.
